(19) United States
(12) Patent Application Publication
(10) Pub. No.: US 2013/0313474 A1
(43) Pub. Date: Nov. 28, 2013

(54) ALKALI METAL MONOCHLORO (ALKALI METAL) SULFAMATE COMPOSITIONS

(71) Applicant: The Clorox Company, (US)

(72) Inventor: Fahim Uddin Ahmed, Greensboro, NC (US)

(21) Appl. No.: 13/871,928

(22) Filed: Apr. 26, 2013

Related U.S. Application Data
(60) Provisional application No. 61/650,938, filed on May 23, 2012.

(51) Int. Cl. C11D 3/395

(52) U.S. Cl. CPC C11D 3/3953
USPC 252/186.44

(57) ABSTRACT

The invention relates to compositions and methods of treatment employing compositions comprising alkali metal monochloro (alkali metal) sulfamates. The compositions include bound hypochlorite, which can be released slowly during use, providing a shelf-stable, color-safe, odor-free cleaning (e.g., laundry) composition. The composition may include (a) 1% to about 30% by weight of a bleaching agent selected from the group consisting of sodium monochloro (sodio) sulfamate, potassium monochloro (potassio) sulfamate, lithium monochloro (lithio) sulfamate, and mixtures thereof; (b) 0.1 to about 20% by weight of a metal hydroxide or metal oxide; and (c) wherein the pH of the composition is greater than 11. The compositions can be used to treat a surface by providing stain removal that is at least comparable to a hypochlorite bleach composition while being color-safe without exhibiting any significant hypochlorite bleach odor.

### CROSS-REFERENCE TO RELATED APPLICATIONS

The present application claims the benefit of U.S. Provisional Patent Application Ser. No. 61/650,938, filed May 23, 2012, the disclosure of which is incorporated by reference in its entirety.

### BACKGROUND OF THE INVENTION

1. The Field of the Invention

The present invention relates to cleaning and sanitizing compositions in which an alkali metal hypochlorite can be slowly released during use, but otherwise remains bound so as to exhibit long shelf-life during storage, no “chlorine bleach” odor, and color-safety characteristics. In addition to such compositions, the invention relates to methods of making and using such compositions.

2. Description of Related Art

Sodium hypochlorite is a highly effective cleaning, bleaching and sanitizing agent that is widely used in cleaning and sanitizing various hard and soft surfaces. For example, aqueous sodium hypochlorite solution is often added to laundry wash water as a performance booster for enhanced stain removal mainly for white clothing. While being an excellent bleaching and sanitizing agent, sodium hypochlorite has many inherent drawbacks such as poor chemical and shelf stability, not being color-safe for washing colored clothing, causing damage to fabric upon extended contact, and exhibiting a characteristic hypochlorite “bleach” odor resulting from its decomposition, which odor some regard as undesirable. These characteristics limit the utility of such solutions.

For example, sodium hypochlorite's chemical stability and shelf life is relatively poor, such that its concentration has to be adjusted upward for use during hot summer months, as it degrades more quickly under such conditions. While sodium hypochlorite itself is technically odorless, it exhibits a perceived “chlorine bleach” odor as a result of formation of hypochlorous acid and chlorine gas upon decomposition of sodium hypochlorite. While sodium hypochlorite is a very effecting cleaning and sanitizing agent for white clothing, it is highly undesirable for laundering colored fabrics due to heavy dye damage (i.e., it is not color-safe). As such, its use is not recommended on colored fabrics. Thus, when a consumer desires the excellent stain and soil removal characteristics provided by sodium hypochlorite, they must separate white fabrics from colored fabrics and launder the loads separately, with separate laundry detergents and separate bleaches—one for whites and the other (e.g., hydrogen peroxide based) for colored clothing. Currently, there are no solutions or technologies available that would provide hypochlorite level stain and soil removal while being safe for use with colored fabrics.

In addition, because of the strong oxidizing characteristics associated with sodium hypochlorite, the flexibility of a manufacturer to include various adjuvants is very limited. For example, there is only a relatively limited group of chelating agents or sequestrants that exhibit relatively good stability in the presence of sodium hypochlorite, which adjuvants are generally not biodegradable. Additionally, there is some new biodegradable chelating agents or sequestrants that have poor visibility with sodium hypochlorite solutions and cannot be used effectively in such compositions. Furthermore, there is only a handful of surfactants available that exhibits relatively good stability in the presence of sodium hypochlorite. Similar problems of stability and incompatibility severely limit choices when it is desired to include various other adjuvants (e.g., fragrances, dyes, optical brighteners, etc.), as many organic moieties and functional groups are incompatible with aqueous hypochlorite.

The inventor has found that such alkali metal monochloro (alkali metal) sulfamate compositions are very stable over time without addition of any separate stabilizing agent, and surprisingly exhibit a level of stain and soil removal that is comparable (and often superior) to that associated with hypochlorite aqueous solutions. In addition, the compositions are color-safe, and free of any significant “bleach” odor typically associated with hypochlorite solutions. It is believed that the alkali metal monochloro (alkali metal) sulfamate complex binds hypochlorite, but allows hypochlorite release to occur (relatively slowly) during use as a result of increased temperature, dilution effects, and/or other circumstances associated with use. The result is that at any given time the amount of available hypochlorite is relatively low, leading to no significant “bleach” odor associated with hypochlorite degradation, while also providing color-safe characteristics so that colored fabrics are not quickly bleached of color upon exposure to the compositions. For example, even upon direct contact with undiluted compositions over an extended period of time (e.g., 10 minutes), no change in color is apparent.

### BRIEF SUMMARY OF THE INVENTION

In one aspect, the present invention is directed to a liquid, aqueous composition comprising (a) about 0.1% to about 30% by weight of a bleaching agent that is an alkali metal monochloro (alkali metal) sulfamate, such as sodium monochloro (sodio) sulfamate, potassium monochloro (potassio) sulfamate, lithium monochloro (lithio) sulfamate, or mixtures thereof; (b) about 0.1% to about 20% by weight of a buffer selected from the group consisting of an alkali metal hydroxide, alkali metal oxide and mixtures thereof; and (c) wherein the pH of the composition is greater than 11.

In another aspect, the present invention is directed to a liquid, aqueous composition comprising (a) about 0.1% to about 20% by weight of a bleaching agent selected from the group consisting of sodium monochloro (sodio) sulfamate, potassium monochloro (potassio) sulfamate, lithium monochloro (lithio) sulfamate, and mixtures thereof; (b) about 0.1% to about 10% by weight of a buffer selected from the group consisting of as an alkali metal hydroxide, alkali metal oxide and mixtures thereof; (c) wherein the composition is essentially free of sodium N-chlorosulfamate and sodium N,N-dichlorosulfamate; and (d) wherein the pH of the composition is greater than 11.

In another aspect, the present invention is directed to a liquid, aqueous laundry composition comprising (a) about 0.1% to about 20% by weight of a bleaching agent selected from the group consisting of sodium monochloro (sodio) sulfamate, potassium monochloro (potassio) sulfamate, lithium monochloro (lithio) sulfamate, and mixtures thereof; (b) about 0.1% to about 5% by weight of a buffer selected from the group consisting of an alkali metal hydroxide, alkali metal oxide and mixtures thereof; and (c) wherein the pH of the composition is greater than 11.

Further features and advantages of the present invention will become apparent to those of ordinary skill in the art in view of the detailed description of preferred embodiments below.

### BRIEF DESCRIPTION OF THE DRAWINGS

To further clarify the above and other advantages and features of the present invention, a more particular description of the invention will be rendered by reference to specific embodiments thereof which are illustrated in the drawings located in the specification. It is appreciated that these drawings depict only typical embodiments of the invention and are therefore not to be considered limiting of its scope. The invention will be described and explained with additional specificity and detail through the use of the accompanying drawings in which:

FIG. 1 plots stability data of stabilized hypochlorite (sodium monochloro (sodio) sulfamate) compositions according to the present invention as compared to a hypochlorite bleach composition (Clorox® Regular-Bleach) and a stabilized hypochlorite (sodium monochloro (sodio) sulfamate) bleach composition with sodium polyacrylate.

FIG. 2 plots stability data of stabilized hypochlorite (sodium monochloro (sodio) sulfamate) compositions according to the present invention made with different sodium hydroxide concentrations as compared to a hypochlorite bleach composition.

FIG. 3 plots ASTM Laundry stain removal performance data for use of a stabilized hypochlorite (sodium monochloro (sodio) sulfamate) composition according to the present invention in combination with Tide® detergent as compared to Tide® detergent alone and compared to Tide® detergent with a regular unstabilized hypochlorite bleach composition.

FIG. 4 plots warm water (93° F.) ASTM Laundry stain removal performance data for use of various stabilized hypochlorite compositions according to the present invention as compared to Tide® Detergent, Clorox 2® Stain Fighter & Color Booster (“LC2”), and Clorox® Oxi Magic™

FIG. 5 plots cold water (68° F.) ASTM Laundry stain removal performance data for use of various stabilized hypochlorite compositions according to the present invention as compared to Tide® detergent and other laundry products.

FIG. 6 plots ASTM Laundry stain performance data for the same compositions as shown in FIG. 5, but under warm water (93° F.) conditions.

FIG. 7 plots ASTM Laundry stain performance data for the same compositions as shown in FIGS. 5 and 6, but under hot water (110° F.) conditions.

### DETAILED DESCRIPTION OF THE PREFERRED EMBODIMENTS

### I. Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to a “surfactant” includes one, two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In the application, effective amounts are generally those amounts listed as the ranges or levels of ingredients in the descriptions, which follow hereto. Unless otherwise stated, amounts listed in percentage (“wt %'s”) are in wt % (based on 100 weight % active) of the particular material present in the referenced composition, any remaining percentage being water or an aqueous carrier sufficient to account for 100% of the composition, unless otherwise noted. For very low weight percentages, the term “ppm” corresponding to parts per million on a weight/weight basis may be used, noting that 1.0 wt % corresponds to 10,000 ppm.

### II. Alkali Metal Monochloro (Alkali Metal) Sulfamate Compositions

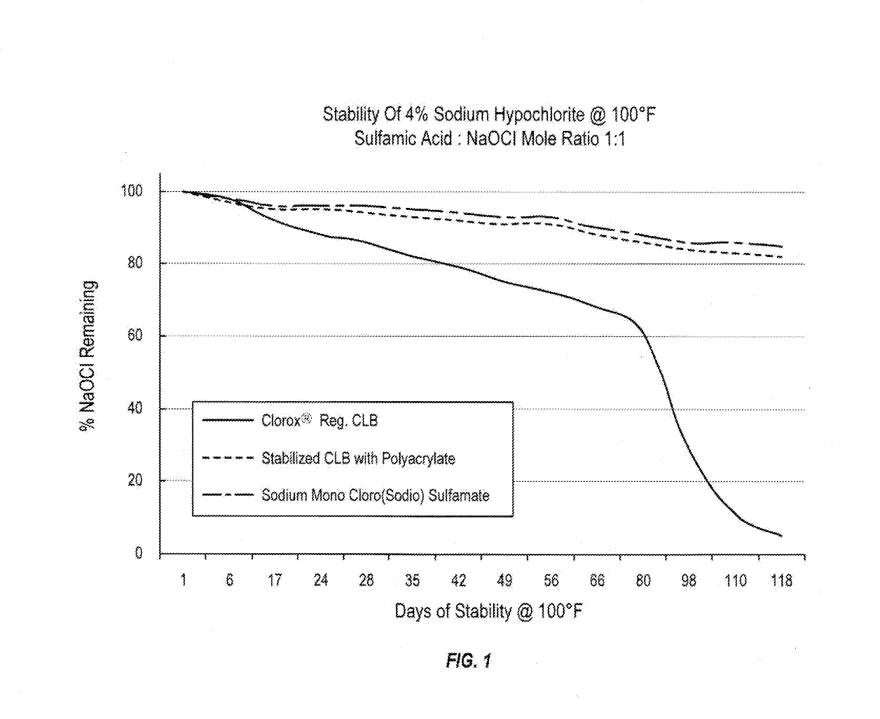

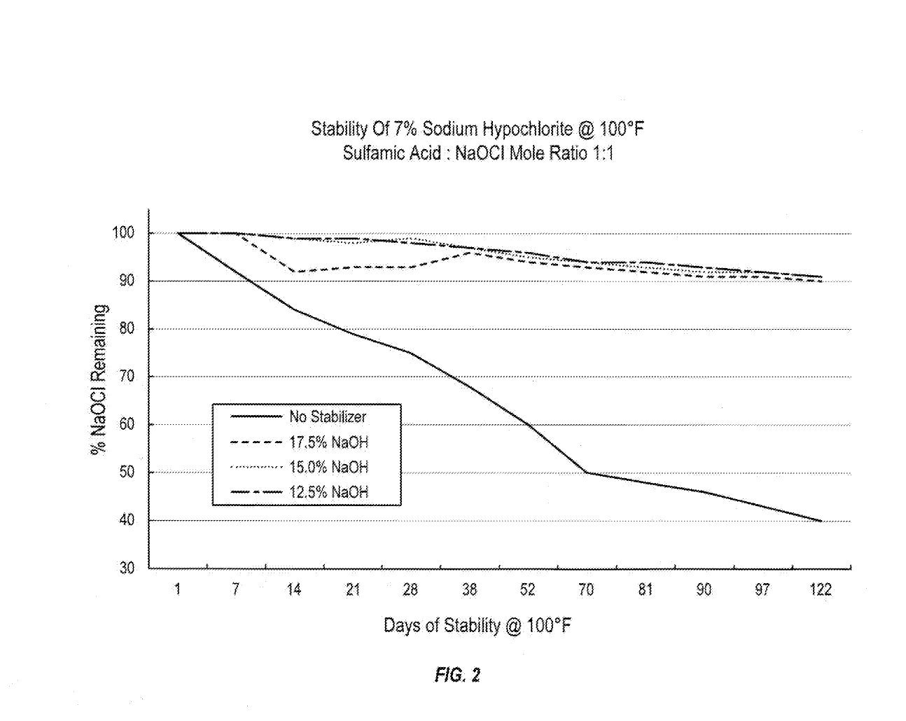

Rather than providing sodium hypochlorite or similar alkali metal hypohalites in an aqueous composition in which the hypochlorite or hypohalite is active or free, the present invention provides a composition capable of slowly releasing hypochlorite so that the hypochlorite (e.g., sodium hypochlorite) is bound or complexed in the form of an alkali metal monochloro (alkali metal) sulfamate. As such, the alkali metal monochloro (alkali metal) sulfamate complex is chemically stable, so that it does not rapidly degrade, even at elevated temperatures, unlike a hypochlorite aqueous solution without stabilizers. In fact, stability testing at an elevated temperature (FIGS. 1 and 2) shows the stability of the alkali metal monochloro (alkali metal) sulfamate aqueous solution is significantly better than the stability of a sodium hypochlorite aqueous solution without a stabilizer and is also significantly better than polyacrylate where the addition of sodium polyacrylate was expected to degrade hypochlorite at much faster in sodium hypochlorite compositions (FIG. 1).

In addition, the composition includes essentially no hypochlorite in stored in active or free form, but is capable of slowly releasing hypochlorite during use of the composition. For example, when used as a laundry product, detergent alkalinity, elevated wash water temperature (as compared to storage environment of the concentrated composition), mechanical action (e.g., agitation in the laundry was a cycle) and the very large dilution ratio (e.g., often about 200:1 to about 600:1) increases the hydrolysis of the alkali metal monochloro (alkali metal) sulfamate complex and results in release of alkali metal hypochlorite during the wash cycle so as to provide efficacious performance, but without releasing so much hypochlorite at any given time so as to result in damage to colored fabrics (i.e., the composition is color-safe) or a “chlorine bleach” odor. For example, dilution of the concentrate composition may be achieved by the consumer with ordinary tap water through pouring into a washing machine, adding the concentrated composition to an automated dispenser incorporated into a washing machine, or by pouring the composition into a vessel containing ordinary tap water.

The compositions may be employed in various environments and uses, such as laundry (e.g., cleaning and sanitizing laundry), hard and soft surface cleaning and sanitizing, dishwashing, industrial or institutional cleaning and/or sanitizing, cleaning and/or sanitizing wipes etc.

Methods of using the composition are also included in this application. Methods of using the composition include contacting the composition with a surface such that the composition cleans, sanitizes and/or disinfects the surface.

Since hypochlorite is bound and not available in an active or free form in sufficiently high concentrations to cause damage to color dyes (even upon use), it does not react or damage dyes on colored fabric. In a similar manner, the composition exhibits significantly extended shelf stability due to the hypochlorite being bound rather than present in a generally active or free form. In addition, as a result of there being very little active or free hypochlorite at any given time, the composition does not release or otherwise exhibit a “chlorine bleach” odor. Finally, because essentially no active or free hypochlorite (which is a strong oxidizer) is present, the composition can advantageously include biodegradable and/or organic chelating agent(s), sequestrant(s), optical brightener/fluorescent whitening agent(s) (“FWA”), surfactant(s), dye(s), fragrance(s), other organic adjuvants that are typically attacked and degraded by free or active hypochlorite or mixtures thereof. Examples including organic chelating agent(s) sequestrant(s), optical brightener(s), or both are shown in Table 7. Such organic adjuvants may advantageously be biodegradable as contrasted to typical hypochlorite stable adjuvants (e.g., polyacrylate sequestrant) which may not be biodegradable.

In some embodiments, any active or free hypochlorite concentration may be less than about 1%, less than about 0.1%, or less than about 0.01% by weight of the composition.

The alkali metal monochloro (alkali metal) sulfamate is believed to generally have the formula Cl—N(Na)SO₃Na:

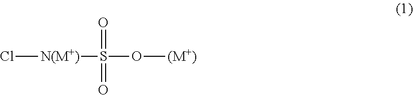

wherein M⁺ is a monovalent alkali metal ion (e.g., Na, K, Li, etc.)

The alkali metal monochloro (alkali metal) sulfamate may be formed by neutralizing sulfamic acid with a suitable base (e.g., an alkali metal hydroxide, an alkali metal oxide, or combinations thereof) as shown in equation (2) below. The alkali metal hydroxide may be provided in an amount somewhat above stoichiometric molar ratio (e.g., above 1:1), to further increase the pH of the final composition and ensure the stability of the resulting alkali metal monochloro (alkali metal) sulfamate complex. For example, the final composition may have an excess amount of the metal hydroxide or metal oxide so as to provide a minimum free alkalinity of about 0.01% to about 25% by weight. The resulting pH may be greater than 11, greater than 12, or from 11 to 14. In an embodiment, the finished composition may include about 0.1% to about 20%, about 0.1% to about 15%, about 0.1% to about 10%, about 0.1% to about 5%, or about 1% to about 5% by weight of the alkali metal hydroxide or alkali metal oxide. For example, in an embodiment, the metal hydroxide or metal oxide may be included in an excess amount above the stoichiometric ratio, where the excess amount is about 0.1% to about 15%, about 0.1% to about 10% or about 1% to about 5% by weight of the final composition.

NH₂SO₃H+NaOH⇄NH₂SO₃Na+H₂O (2)

For example, equation (2) shows a specific example of formation of sodium sulfamate by reaction of sulfamic acid with sodium hydroxide. The reaction shown in equation (2) is highly exothermic. The reaction product (an aqueous solution of sodium sulfamate) may be cooled to ambient temperature (or below ambient temperature) prior to proceeding to form the alkali metal monochloro (alkali metal) sulfamate complex.

NH₂SO₃Na+NaOCl⇄Cl—NHSO₃Na+NaOH (3)

Cl—NHSO₃Na+NaOH⇄Cl—N⁻(Na⁺)SO₃Na+H₂O (4)

Equations (3) and (4) show how the cooled sodium sulfamate may then be mixed with an alkali metal hypochlorite (e.g., sodium hypochlorite), resulting in the eventual formation of the desired alkali metal monochloro (alkali metal) sulfamate complex. It will be noted that in an embodiment, no contact between the hypochlorite (e.g., NaOCl) and sulfamic acid occurs,—rather the sulfamic acid is first neutralized to an alkali metal sulfamic acid salt before contact with any hypochlorite occurs. The molar ratios of the sulfamic acid and alkali metal hydroxide or alkali metal oxide may be carefully selected to ensure that substantially all sulfamic acid is reacted and no excess sulfamic acid is present before addition of the hypochlorite. For example, the molar ratio of the alkali metal hydroxide or oxide may be at least 1:1 or for alkali metal oxide the mole ratio may be at least 0.5:1 relative to the sulfamic acid to ensure all sulfamic acid is reacted. It is believed that after reacting with the hypochlorite at equal molar concentrations (i.e., a 1:1 ratio of sodium sulfamate to sodium hypochlorite), an intermediate Cl—NHSO₃Na is formed, which is immediately deprotonated in alkaline solution, forming the desired alkali metal monochloro (alkali metal) sulfamate complex (e.g., Cl—N⁻(Na⁺) SO₃Na).

Such formation occurs before any dichloro sulfamate compound (e.g., Cl₂NSO₃Na) can be formed according to equation (5), below.

ClHNSO₃Na+NaOCl⇄Cl₂NSO₃Na+NaOH (5)

As such, the composition may be free or essentially free of sodium N-chlorosulfamate and sodium N,N-dichlorosulfamate or analogous compounds based on other alkali metal chemistry (e.g., lithium or potassium N-chlorosulfamate/N,N-dichlorosulfamate).

Such monochloro and dichloro sulfamate compounds are easily formed in acidic or buffered pH systems, but they decompose very quickly in the present highly alkaline systems. In addition, such dichloro sulfamate compounds are undesirable in compositions of the present invention as they tend to exhibit relatively fast hydrolysis of the first N—Cl bond, releasing hypochlorite at a significantly higher rate in solution than the described alkali metal monochloro (alkali metal) sulfamate complexes. As a result, such di-chloro sulfamate compounds are not capable of providing color-safety, but instead result in damage to dyes in colored fabrics. In a similar manner, they may exhibit a “chlorine bleach” odor due to higher hydrolysis of the N—Cl bond and subsequent degradation of hypochlorite.

Because such monochloro and dichloro sulfamate compounds are unstable at the described pH conditions, the most stable configuration for the components under the highly alkaline conditions is the alkali metal monochloro (alkali metal) sulfamate complex, such as that identified by chemical structure (1). Such complexes have been found to provide color-safe, odor-free cleaning characteristics with long term stability.

Alternatively, one may simply begin with the alkali metal salt of sulfamic acid (e.g., sodium sulfamate), rather than neutralizing the acid with an alkali metal hydroxide or oxide. In an embodiment, and as described above, an excess amount of the hydroxide (i.e., beyond neutralization of sulfamic acid) is provided to ensure the desired stable sodium monochloro (sodio) sulfamate is formed.

It will be readily apparent that in the described method of preparation, the sodium hypochlorite or other alkali metal hypochlorite is not contacted with sulfamic acid, but with the sulfamic acid salt (e.g., sodium sulfamate) under specifically controlled conditions (e.g., an excess of sodium hydroxide) to form sodium monochloro (sodio) sulfamate. In other words, in an embodiment, no mixture of sulfamic acid, sodium hypochlorite, and sodium hydroxide is ever formed.

Any suitable alkali metal hydroxide or alkali metal oxide may be used to provide the desired relatively high pH. Alkaline earth metal hydroxides and alkaline earth metal oxides can also be used in the present invention. Exemplary components include alkali metal hydroxides, alkaline earth metal hydroxides, alkali metal oxides, and alkaline earth metal oxides (e.g., lithium hydroxide, lithium oxide, sodium hydroxide, sodium oxide, potassium hydroxide, potassium oxide, calcium hydroxide, calcium oxide, magnesium hydroxide, magnesium oxide, etc.). The amount of the metal hydroxide or metal oxide employed in the formulation may be from about 0.1% to about 25%, about 0.1% to about 20%, about 0.1% to about 10%, or about 1% to about 5% by weight of the composition. Where the alkali metal hydroxide or alkali metal oxide is used to neutralize sulfamic acid to form the desired alkali metal salt of sulfamic acid, alkaline earth metal hydroxides, alkaline earth metal oxides, or combinations thereof may be used. Such may be provided in excess, as described above.

The amount of the alkali metal monochloro (alkali metal) sulfamate in the finished composition may be from about 0.1% to about 30%, about 0.1% to about 25%, about 1% to about 20%, about 0.1% to about 15%, about 0.1% to about 10%, or from about 15% to about 25% by weight of the composition. Several examples below show compositions including about 16% by weight of sodium monochloro (sodio) sulfamate. Any suitable alkali metal component(s) may be employed in forming the complex. In some embodiments, where a combination of alkali metals are employed, the resulting formulation may include combinations of alkali metal monochloro (alkali metal) sulfamates.

For example, typically, two atoms (or moles) of alkali metals will be employed to form the present alkali metal monochloro (alkali metal) sulfamate species. The alkali metal bases can be used alone or mixed. Similarly, one or a combination of alkali metal hypochlorites may be used alone or mixed. Depending on the concentration of base(s) and/or hypochlorites used, a multitude of chlorosulfamate species can potentially be formed as elaborated below. For example with sulfamic acid, if NaOH and NaOCl are used alone; it will produce sodium monochloro (sodio) sulfamate. If KOH and KOCl are used alone, it will produce potassium monochloro (potassio) sulfamate. If LiOH and LiOCl are used alone; it will produce lithium monochloro (lithio) sulfamate. If NaOH is used with KOH (or NaOCl and KOCl), it could produce a mixture of salts, such as sodium monochloro (sodio) sulfamate, potassium monochloro (potassio) sulfamate, potassium monochloro (sodio) sulfamate, and sodium monochloro (potassio) sulfamate. If NaOH were used with LiOH (or NaOCl and LOCl), it could produce a mixture of salts, such as sodium monochloro (sodio) sulfamate, lithium monochloro (lithio) sulfamate, lithium monochloro (sodio) sulfamate, and sodium monochloro (lithio) sulfamate. If LiOH were used with KOH (or LiOCl and KOCl), it could produce a mixture of salts, such as lithium monochloro (lithio) sulfamate, potassium monochloro (potassio) sulfamate, potassium monochloro (lithio) sulfamate, and lithium monochloro (potassio) sulfamate. Other combinations, and methods for their preparation will be apparent to one of skill in the art in light of the present disclosure.

Various water soluble builders and sequestrants as known in the art may be employed. Exemplary builder salts include, but are not limited to, alkali metal detergent builder salts, particularly the alkali metal polyphosphates and phosphonates. Examples of these builder salts include, but are not limited to, alkali metal pyrophosphates (e.g., tetrasodium or tetrapotassium pyrophosphates), alkali metal tripolyphosphates (e.g., sodium or potassium tripolyphosphate, either anhydrous or hydrated), alkali metal metaphosphates (e.g., sodium or potassium hexametaphosphates), and the like (e.g., trisodium or tripotassium orthophosphate).

It is also possible to employ hypochlorite stable inorganic builders such as alkali metal borates, carbonates and bicarbonates, and water insoluble aluminosilicates or zeolites, both crystalline and amorphous. More specific examples include sodium tetraborate, sodium carbonate, sodium bicarbonate, sodium sesquicarbonate, potassium carbonate, potassium bicarbonate, sodium and potassium zeolites. Exemplary organic non-phosphate builders and sequestrant salts include alkali metal salts of polycarboxylic acids and nitriloacetic acid. More specific examples include monosodium, disodium and trisodium citrate, and tetrasodium ethylenediaminetetraacetate (EDTA-Na₄). Salts of organic acids (e.g., citric acid and tartaric acid, glutamic acid), and amino acid based components may also be suitable.

Exemplary specific chelating agent sequestrants and/or optical brightener components that may be used include, but are not limited to, sodium polyacrylate (e.g., ACCUSOL™ 445N), Na₃ methyl glycine diacetate (e.g., TRILON® M LIQUID), Na₄ glutamic acid diacetate (DISSOLVINE® GL47S), hybrid biopolymers (e.g., ALCOGUARD® HS5240), sodium polyitaconate (e.g., ITACONIX™ DSP2K-US), Naₓ carboxymethyl inulin (COSUN CMI 25-40D or DEQUEST® SPE 15625), TINOSORB FB, and combinations thereof. Examples of such formulations are shown in Table 7.

These oxidation-prone organic chelating agents and sequestrants listed in the preceding paragraph are readily biodegradable and stable in non-bleaching compositions. In hypochlorite compositions, these organic chelating agents and sequestrants are unstable due to degradation of oxidizable functional groups present in the molecules by hypochlorite. However, these chelating agents showed remarkable stability in stabilized hypochlorite compositions containing sodium monochloro (sodio) sulfamate, without stabilizers. This unexpected stability and compatibility results paved the way to formulate sodium hypochlorite bleach with these performance-boosting agents to improve cleaning performance in a way that was not even possible before.

Various polyacrylates are of course suitable for use. Examples of such sequestrants are disclosed in U.S. Pat. Nos. 6,211,131 and 6,297,209, each of which is herein incorporated by reference in its entirety.

Various fragrances and dyes, whether stable in the presence of hypochlorite or not, may similarly be employed, as will be apparent in light of the present disclosure. Even those fragrances and dyes including various organic functional groups or other organic moieties which may be notoriously unstable in the presence of hypochlorite may advantageously be employed without fear of instability of such adjuvants, as any “free” or “active” hypochlorite concentration is very low.

In an embodiment, one or more silicate components (e.g., hydrated or anhydrous) may be included. Exemplary silicates include silicate salts, such as alkali metal and alkaline earth salts of silicate, metasilicate, polysilicate. The term silicate is meant to encompass silicate, metasilicate, disilicate, trisilicate, polysilicate, aluminosilicate and similar compounds. Silicate classifications are based on compositions of alkali metal oxide to silicon dioxide weight or mole ratios that make up silicate compositions. Silicate containing stabilized hypochlorite formulations are shown in Tables 2-4.

The compositions of the present invention may contain surfactants selected from nonionic, anionic, cationic, ampholytic, amphoteric and zwitterionic surfactants and mixtures thereof. A typical listing of anionic, ampholytic, and zwitterionic classes, and species of these surfactants, is given in U.S. Pat. No. 3,929,678 to Laughlin and Heuring. A list of suitable cationic surfactants is given in U.S. Pat. No. 4,259,217 to Murphy. Additional details of various surfactants that may be suitable for use are found in U.S. Publication 2013/0028990. Each of the foregoing patents and application are herein incorporated by reference in their entirety. Exemplary specific surfactants, at least some of which may be unstable in the presence of hypochlorite that may be used include, but are not limited to sodium lauryl ether sulfate, sodium lauryl sulfate, sodium dodecylbenzene sulfonates, nonionic surfactants such as alkyl polyglucoside (APGs), alkyl ethoxylated alcohols, alkyl ethoxy/propoxylated alcohols and combinations thereof.

The composition may include one or more preservatives. When used, such adjuvants may include, but are not limited to, mildewstat or bacteriostat, methyl, ethyl and propyl parabens, phosphates such as trisodium phosphate, short chain organic acids (e.g. acetic, lactic and/or glycolic acids), bisguanidine compounds (e.g. DANTAGARD and/or GLYDANT) and/or short chain alcohols (e.g. ethanol and/or IPA). Additional details of exemplary preservatives are disclosed in U.S. Publication 2013/0028990, already incorporated herein by reference.

Surfactants, silicates, builders, sequestrants, chelating agents, preservatives, fluorescent whitening agents, optical brighteners, fragrances, and any other adjuvants may be included in appropriate, effective amounts. In some embodiments, such levels may be from about 0% to about 90%, or from about 0.001% to about 50%, or from about 0.01% to about 25% by weight. Alternatively, any given adjuvant or class of adjuvants may be present at a level of from about 0.1 to about 10% by weight, or from about 0.1 to about 5% by weight, or from about 0.1 to about 1% by weight.

Various exemplary formulations that were formed are shown in the Tables below.

TABLE 1A

| | Ingredient | Target |
|---|---|---|
| Sodium Hypochlorite (14.55%) | 14.55% | 7.00% |

| | 7.36% Av Cl₂ | | | | | |
|---|---|---|---|---|---|---|
| | 16.51% Sodium Monochlorosodio Sulfamate | | | | | |
| | (Equivalent to 7.00% NaOCl) | | | | | |
| | Ex 0 | Ex 1 | Ex 2 | Ex 3 | Ex 4 | Ex 5 |
| Ingredients | | Clorox ® Regular Bleach | | | | |
| Water (Deionized) | 7.32 | 18.89 | 22.79 | 26.70 | 30.60 | 34.51 |
| Sodium Hydroxide (50%) | 35.00 | 23.43 | 19.53 | 15.62 | 11.72 | 7.81 |
| Sulfamic Acid (99%) | 9.57 | 9.57 | 9.57 | 9.57 | 9.57 | 9.57 |
| Sodium Hypochlorite (14.55%) | 48.11 | 48.11 | 48.11 | 48.11 | 48.11 | 48.11 |
| Sodium Monochlorosodio Sulfamate, | | | | | | |
| MW 175.5225 | | | | | | |
| | 100.00 | 100.00 | 100.00 | 100.00 | 100.00 | 100.00 |

| | Ex 1 | Ex 2 | Ex 3 | Ex 4 | Ex 5 |
|---|---|---|---|---|---|
| pH of the Finished Formulation (Neat) | 13.52 | 13.43 | 13.33 | 13.19 | 12.56 |
| pH of the Wash Dilution Formulation | 11.89 | 11.82 | 11.69 | 11.55 | 11.30 |
| (½ cup in 68 L water) | | | | | |
| pH of the Wash Dilution Formulation | 11.68 | 11.62 | 11.53 | 11.41 | 11.24 |
| (¾ cup in 68 L water) | | | | | |

TABLE 1B

| | Ingredient | Target |
|---|---|---|
| Sodium Hypochlorite (14.55%) | 14.55% | 7.00% |

7.36% Av Cl₂
16.51% Sodium Monochlorosodio Sulfamate

| | | Ex 1 | Ex 2 | Ex 3 | Ex 4 | Ex 5 |
|---|---|---|---|---|---|---|
| Ingredients | Ex 0 | Clorox ® Regular Bleach | | | | |
| Water (Deionized) | 38.92 | 50.49 | 54.39 | 58.30 | 62.20 | 66.11 |
| Sodium Hydroxide (50%) | 35.00 | 23.43 | 19.53 | 15.62 | 11.72 | 7.81 |
| Sulfamic Acid (99%) | 9.57 | 9.57 | 9.57 | 9.57 | 9.57 | 9.57 |
| Sodium Hypochlorite (14.55%) | | | | | | |
| Sodium Monochlorosodio | 16.51 | 16.51 | 16.51 | 16.51 | 16.51 | 16.51 |
| Sulfamate, MW 175.5225 | | | | | | |
| | 100.00 | 100.00 | 100.00 | 100.00 | 100.00 | 100.00 |
| | | Ex 1 | Ex 2 | Ex 3 | Ex 4 | Ex 5 |
| pH of the Finished Formulation (Neat) | | 13.52 | 13.43 | 13.33 | 13.19 | 12.56 |
| pH of the Wash Dilution Formulation | | 11.89 | 11.82 | 11.69 | 11.55 | 11.30 |
| (½ cup in 68 L water) | | | | | | |
| pH of the Wash Dilution Formulation | | 11.68 | 11.62 | 11.53 | 11.41 | 11.24 |
| (¾ cup in 68 L water) | | | | | | |

The Examples shown in Tables 1A and 1B show various formulations made with varying amounts of sodium hydroxide, each including 16.51 weight percent sodium monochloro (sodio) sulfamate equivalent to 7.36% available chlorine in the final compositions. Table 1A shows weight fractions of the reaction components that go into making the final composition, while Table 1B shows the concentration of sodium monochloro (sodio) sulfamate. It is noted that the final composition is not a simple mixture of components shown in Table 1A, as reaction between components occurs as they are added to one another in a specific order, as described above. Many of the other Tables employ a similar scheme, showing weight fractions of the various reactants used to form the alkali metal monochloro (sodio) sulfamate compositions.

TABLE 2

| | | Anhydrous Sodium Metasilicate Optimization & Stability | | | | | | | | | | | |
|---|---|---|---|---|---|---|---|---|---|---|---|---|---|
| | | | | | | | | Sodium | | | | | |
| | | Sodium | | Sodium | | | | Silicate | Sodium | | | | |
| | | Hypochlorite | | Monochlo- | | | | Anhydrous | Monochlo- | | Initial Data | | |
| | | (16.05%)-Low | | rosodio | | | Sodium | (MW | rosodio | | | | % (By |
| | | Salt | | Sulfamate, | | Water | Hydrox- | 122.06; | Sulfamate, | | | | Phenol- |
| | | High | | MW | Ingre- | (Deion- | ide | Na2O:SiO2 | MW | | NaOCl, | | phthalein |
| | | Strength | | 175.5225 | dients | ized) | (50%) | 1:1) | 175.5225 | | % | pH | Titration) |
| Low | 16.6750% | Target | 6.50% | 15.33% | Ex 6 | 82.67 | 0.00 | 2.00 | 15.33 | 100.00 | 5.974 | 12.58 | 0.807 |
| Salt | | Target | 6.50% | 15.33% | Ex 7 | 82.47 | 0.20 | 2.00 | 15.33 | 100.00 | 6.063 | 12.63 | 0.282 |
| High | | Target | 6.50% | 15.33% | Ex 8 | 82.27 | 0.40 | 2.00 | 15.33 | 100.00 | 6.059 | 12.65 | 0.209 |
| Strength | | Target | 6.50% | 15.33% | Ex 9 | 82.07 | 0.60 | 2.00 | 15.33 | 100.00 | 6.151 | 12.72 | 0.366 |
| NaOCl | | Target | 6.50% | 15.33% | Ex 10 | 81.87 | 0.80 | 2.00 | 15.33 | 100.00 | 6.209 | 12.75 | 1.033 |
| Stock | | Target | 6.50% | 15.33% | Ex 11 | 81.67 | 1.00 | 2.00 | 15.33 | 100.00 | 6.213 | 12.75 | 0.172 |
| | | Target | 6.50% | 15.33% | Ex 12 | 81.47 | 1.20 | 2.00 | 15.33 | 100.00 | 6.246 | 12.73 | 0.383 |
| | | Target | 6.50% | 15.33% | Ex 13 | 81.27 | 1.40 | 2.00 | 15.33 | 100.00 | 6.268 | 12.79 | 0.088 |
| | | Target | 6.50% | 15.33% | Ex 14 | 81.07 | 1.60 | 2.00 | 15.33 | 100.00 | 6.278 | 12.75 | 0.242 |
| | | Target | 6.50% | 15.33% | Ex 15 | 80.87 | 1.80 | 2.00 | 15.33 | 100.00 | 6.262 | 12.80 | 0.856 |
| | | Target | 6.50% | 15.33% | Ex 16 | 80.67 | 2.00 | 2.00 | 15.33 | 100.00 | 6.337 | 13.02 | 0.723 |
| | | Target | 6.50% | 15.33% | Control | 82.67 | 0.00 | 2.00 | 15.33 | 100.00 | 6.366 | 12.62 | 1.238 |
| | | Target | 6.50% | 15.33% | Ex 17 | 80.47 | 2.20 | 2.00 | 15.33 | 100.00 | 6.339 | 13.00 | 1.153 |
| | | Target | 6.50% | 15.33% | Ex 18 | 80.27 | 2.40 | 2.00 | 15.33 | 100.00 | 6.211 | 12.97 | 1.243 |
| | | Target | 6.50% | 15.33% | Ex 19 | 79.87 | 2.80 | 2.00 | 15.33 | 100.00 | | | |
| | | Target | 6.50% | 15.33% | Ex 20 | 79.67 | 3.00 | 2.00 | 15.33 | 100.00 | 6.170 | 13.04 | 1.708 |
| | | | | | (old) | | | | | | | | |
| | | Target | 6.50% | 15.33% | Ex 21 | 81.27 | 1.00 | 2.40 | 15.33 | 100.00 | 6.5332 | 12.98 | 1.542 |
| | | Target | 6.50% | 15.33% | Ex 20 | 81.07 | 1.20 | 2.40 | 15.33 | 100.00 | 6.5184 | 12.91 | 1.801 |
| | | Target | 6.50% | 15.33% | Ex 22 | 80.87 | 1.40 | 2.40 | 15.33 | 100.00 | 6.4641 | 12.89 | 1.507 |
| | | Target | 6.50% | 15.33% | Ex 23 | 80.67 | 1.60 | 2.40 | 15.33 | 100.00 | 6.7723 | 13.01 | 1.743 |
| | | Target | 6.50% | 15.33% | Ex 24 | 80.47 | 1.80 | 2.40 | 15.33 | 100.00 | 6.3485 | 12.97 | 1.827 |
| | | Target | 6.50% | 15.33% | Ex 25 | 80.27 | 2.00 | 2.40 | 15.33 | 100.00 | 6.4505 | 12.97 | 1.894 |
| | | Target | 6.50% | 15.33% | Ex 26 | 82.07 | 1.00 | 1.60 | 15.33 | 100.00 | 6.0634 | 12.77 | 1.178 |
| | | Target | 6.50% | 15.33% | Ex 27 | 81.87 | 1.20 | 1.60 | 15.33 | 100.00 | 6.421 | 12.81 | 1.076 |
| | | Target | 6.50% | 15.33% | Ex 28 | 81.67 | 1.40 | 1.60 | 15.33 | 100.00 | 6.487 | 12.8 | 1.318 |
| | | Target | 6.50% | 15.33% | Ex 29 | 81.47 | 1.60 | 1.60 | 15.33 | 100.00 | 6.4084 | 12.95 | 1.399 |
| | | Target | 6.50% | 15.33% | Ex 30 | 81.27 | 1.80 | 1.60 | 15.33 | 100.00 | 6.3895 | 12.91 | 1.716 |
| | | Target | 6.50% | 15.33% | Ex 31 | 81.07 | 2.00 | 1.60 | 15.33 | 100.00 | 5.8354 | 12.78 | 1.509 |
| | | Target | 6.50% | 15.33% | Ex 32 | 80.07 | 3.00 | 1.60 | 15.33 | 100.00 | | | |
| | | Target | 8.25% | 19.46% | Ex 33 | 80.07 | 3.00 | 1.60 | 15.33 | 100.00 | | | |

Table 2 shows various formulations made to include 15.33 weight percent sodium monochloro (sodio) sulfamate equivalent to 6.50% of available chlorine, and including various concentrations of an anhydrous sodium metasilicate (e.g., from about 1.6 weight percent to about 2.4 weight percent), and varying amounts of excess sodium hydroxide (e.g., 0 weight percent excess to 3 weight percent excess).

TABLE 3
Hydrated Sodium Metasilicate Optimization & Stability

| | | | Sodium | | | | | Sodium | |
|---|---|---|---|---|---|---|---|---|---|
| | | Sodium | Monochloro- | | | | Sodium | Monochloro- | |
| | | Hypochlorite | sodio | | | | Silicate•5H₂O | sodio | |
| | | (16.05%)-Low | Sulfamate, | | | Sodium | (MW 212; | Sulfamate, | |
| | | Salt High | MW | Ingre- | Water | Hydroxide | Na2O:SiO2 | MW | |
| | | Strength | 175.5225 | dients | (Deionized) | (50%) | 1:1) | 175.5225 | |
| Low Salt | 16.6750% | Target 6.50% | 15.33% | Ex 34 | 81.19 | 0.00 | 3.48 | 15.33 | 100.00 |
| High | | Target 6.50% | 15.33% | Ex 35 | 80.19 | 1.00 | 3.48 | 15.33 | 100.00 |
| Strength | | Target 6.50% | 15.33% | Ex 36 | 79.99 | 1.20 | 3.48 | 15.33 | 100.00 |
| NaOCl | | Target 6.50% | 15.33% | Ex 37 | 79.79 | 1.40 | 3.48 | 15.33 | 100.00 |
| Stock | | Target 6.50% | 15.33% | Ex 38 | 79.59 | 1.60 | 3.48 | 15.33 | 100.00 |
| | | Target 6.50% | 15.33% | Ex 39 | 79.39 | 1.80 | 3.48 | 15.33 | 100.00 |
| | | Target 6.50% | 15.33% | Ex 40 | 79.19 | 2.00 | 3.48 | 15.33 | 100.00 |
| | | Target 6.50% | 15.33% | Ex 41 | 79.49 | 1.00 | 4.18 | 15.33 | 100.00 |
| | | Target 6.50% | 15.33% | Ex 42 | 79.29 | 1.20 | 4.18 | 15.33 | 100.00 |
| | | Target 6.50% | 15.33% | Ex 43 | 79.09 | 1.40 | 4.18 | 15.33 | 100.00 |
| | | Target 6.50% | 15.33% | Ex 44 | 78.89 | 1.60 | 4.18 | 15.33 | 100.00 |
| | | Target 6.50% | 15.33% | Ex 45 | 78.69 | 1.80 | 4.18 | 15.33 | 100.00 |
| | | Target 6.50% | 15.33% | Ex 46 | 78.49 | 2.00 | 4.18 | 15.33 | 100.00 |
| | | Target 6.50% | 15.33% | Ex 47 | 80.88 | 1.00 | 2.79 | 15.33 | 100.00 |
| | | Target 6.50% | 15.33% | Ex 48 | 80.68 | 1.20 | 2.79 | 15.33 | 100.00 |
| | | Target 6.50% | 15.33% | Ex 49 | 80.48 | 1.40 | 2.79 | 15.33 | 100.00 |
| | | Target 6.50% | 15.33% | Ex 50 | 80.28 | 1.60 | 2.79 | 15.33 | 100.00 |
| | | Target 6.50% | 15.33% | Ex 51 | 80.08 | 1.80 | 2.79 | 15.33 | 100.00 |
| | | Target 6.50% | 15.33% | Ex 52 | 79.88 | 2.00 | 2.79 | 15.33 | 100.00 |

Table 3 shows various formulations made to include 15.33 weight percent sodium monochloro (sodio) sulfamate, and including various concentrations of a hydrated sodium metasilicate (e.g., from about 2.79 weight percent to about 4.18 weight percent), and varying amounts of excess sodium hydroxide (e.g., 0 weight percent excess to 2 weight percent excess).

TABLE 4
Hydrated Sodium Metasilicate Optimization & Stability

| | | | Sodium | | | | | | Sodium | |
|---|---|---|---|---|---|---|---|---|---|---|
| | | Sodium | Monochloro- | | | | | Sodium | Monochloro- | |
| | | Hypochlorite | sodio | | | | | Silicate•5H₂O | sodio | |
| | | (16.05%)-Low | Sulfamate, | | | | Sodium | (MW 212; | Sulfamate, | |
| | | Salt High | MW | | Ingre- | Water | Hydroxide | Na2O:SiO2 | MW | |
| | | Strength | 175.5225 | | dients | (Deionized) | (50%) | 1:1) | 175.5225 | |
| Low Salt | 16.0466% | Target 6.50% | 15.33% | 6.5% NaOCl | Ex 53 | 79.07 | 1.20 | 4.40 | 15.33 | 100.00 |
| High | | Target 6.50% | 15.33% | 6.5% NaOCl | Ex 54 | 78.87 | 1.20 | 4.60 | 15.33 | 100.00 |
| Strength | | Target 6.50% | 15.33% | 6.5% NaOCl | Ex 55 | 78.67 | 1.20 | 4.80 | 15.33 | 100.00 |
| NaOCl | | Target 6.50% | 15.33% | 6.5% NaOCl | Ex 56 | 78.47 | 1.20 | 5.00 | 15.33 | 100.00 |
| Stock | | Target 6.50% | 15.33% | 6.5% NaOCl | Ex 57 | 78.27 | 1.20 | 5.20 | 15.33 | 100.00 |
| | | Target 6.50% | 15.33% | 6.5% NaOCl | Ex 58 | 78.87 | 1.40 | 4.40 | 15.33 | 100.00 |
| | | Target 6.50% | 15.33% | 6.5% NaOCl | Ex 59 | 78.67 | 1.40 | 4.60 | 15.33 | 100.00 |
| | | Target 6.50% | 15.33% | 6.5% NaOCl | Ex 60 | 78.47 | 1.40 | 4.80 | 15.33 | 100.00 |
| | | Target 6.50% | 15.33% | 6.5% NaOCl | Ex 61 | 78.27 | 1.40 | 5.00 | 15.33 | 100.00 |
| | | Target 6.50% | 15.33% | 6.5% NaOCl | Ex 62 | 78.07 | 1.40 | 5.20 | 15.33 | 100.00 |
| | | Target 6.50% | 15.33% | 6.5% NaOCl | Ex 63 | 78.67 | 1.60 | 4.40 | 15.33 | 100.00 |
| | | Target 6.50% | 15.33% | 6.5% NaOCl | Ex 64 | 78.47 | 1.60 | 4.60 | 15.33 | 100.00 |
| | | Target 6.50% | 15.33% | 6.5% NaOCl | Ex 65 | 78.27 | 1.60 | 4.80 | 15.33 | 100.00 |
| | | Target 6.50% | 15.33% | 6.5% NaOCl | Ex 66 | 78.07 | 1.60 | 5.00 | 15.33 | 100.00 |
| | | Target 6.50% | 15.33% | 6.5% NaOCl | Ex 67 | 77.87 | 1.60 | 5.20 | 15.33 | 100.00 |
| | | Target 6.50% | 15.33% | 6.5% NaOCl | Ex 68 | 78.47 | 1.80 | 4.40 | 15.33 | 100.00 |
| | | Target 6.50% | 15.33% | 6.5% NaOCl | Ex 69 | 78.27 | 1.80 | 4.60 | 15.33 | 100.00 |
| | | Target 6.50% | 15.33% | 6.5% NaOCl | Ex 70 | 78.07 | 1.80 | 4.80 | 15.33 | 100.00 |
| | | Target 6.50% | 15.33% | 6.5% NaOCl | Ex 71 | 77.87 | 1.80 | 5.00 | 15.33 | 100.00 |
| | | Target 6.50% | 15.33% | 6.5% NaOCl | Ex 72 | 77.67 | 1.80 | 5.20 | 15.33 | 100.00 |
| | | Target 6.50% | 15.33% | 6.5% NaOCl | Ex 73 | 78.27 | 2.00 | 4.40 | 15.33 | 100.00 |
| | | Target 6.50% | 15.33% | 6.5% NaOCl | Ex 74 | 78.07 | 2.00 | 4.60 | 15.33 | 100.00 |
| | | Target 6.50% | 15.33% | 6.5% NaOCl | Ex 75 | 77.87 | 2.00 | 4.80 | 15.33 | 100.00 |
| | | Target 6.50% | 15.33% | 6.5% NaOCl | Ex 76 | 77.67 | 2.00 | 5.00 | 15.33 | 100.00 |
| | | Target 6.50% | 15.33% | 6.5% NaOCl | Ex 77 | 77.47 | 2.00 | 5.20 | 15.33 | 100.00 |
| | | Target 6.50% | 15.33% | 6.5% NaOCl | Ex 78 | 78.07 | 2.20 | 4.40 | 15.33 | 100.00 |
| | | Target 6.50% | 15.33% | 6.5% NaOCl | Ex 79 | 77.87 | 2.20 | 4.60 | 15.33 | 100.00 |
| | | Target 6.50% | 15.33% | 6.5% NaOCl | Ex 80 | 77.67 | 2.20 | 4.80 | 15.33 | 100.00 |
| | | Target 6.50% | 15.33% | 6.5% NaOCl | Ex 81 | 77.47 | 2.20 | 5.00 | 15.33 | 100.00 |
| | | Target 6.50% | 15.33% | 6.5% NaOCl | Ex 82 | 77.27 | 2.20 | 5.20 | 15.33 | 100.00 |
| | | Target 8.25% | 19.42% | 8.25% NaOCl | Ex 83 | 74.18 | 2.00 | 4.40 | 19.42 | 100.00 |
| | | Target 8.25% | 19.42% | 8.25% NaOCl | Ex 84 | 73.98 | 2.00 | 4.60 | 19.42 | 100.00 |
| | | Target 8.25% | 19.42% | 8.25% NaOCl | Ex 85 | 73.78 | 2.00 | 4.80 | 19.42 | 100.00 |
| | | Target 8.25% | 19.42% | 8.25% NaOCl | Ex 86 | 73.58 | 2.00 | 5.00 | 19.42 | 100.00 |
| | | Target 8.25% | 19.42% | 8.25% NaOCl | Ex 87 | 73.38 | 2.00 | 5.20 | 19.42 | 100.00 |

Table 4 shows additional various formulations made to include 15.33 weight percent sodium monochloro (sodio) sulfamate, and including various concentrations of a hydrated sodium metasilicate (e.g., from about 4.4 weight percent to about 5.2 weight percent), and varying amounts of excess sodium hydroxide (e.g., 1.2 weight percent excess to 2.2 weight percent excess).

TABLE 5
Use of Sodium Monochloro(sodio) sulfamate

| | Ingredient | Target |
|---|---|---|
| Sodium Hypochlorite (14.55%) | 14.55% | 7.00% |

| | |
|---|---|
| Laundry Testing @ CTC, | 7.36% Av Cl2 |
| ASTM Stained Flags | |
| 100 ppm HW, Top Loader, ¾ | 7.00% NaOCl |
| cup, 5 min delay | |

| | | | Ex 1 | Ex 2 | Ex 3 | Ex 4 | Ex 5 |
|---|---|---|---|---|---|---|---|
| Ingredients | Control | Ex 0 | Clorox ® Regular Bleach | | | | |
| Water (Deionized) | 51.89 | 7.32 | 18.89 | 22.79 | 26.7 | 30.6 | 34.51 |
| Sodium Hydroxide | 0.00 | 35.00 | 23.43 | 19.53 | 15.62 | 11.72 | 7.81 |
| (50%) | | | | | | | |
| Sulfamic Acid (99%) | 0.00 | 9.57 | 9.57 | 9.57 | 9.57 | 9.57 | 9.57 |
| Sodium Hypochlorite | 48.11 | 48.11 | 48.11 | 48.11 | 48.11 | 48.11 | 48.11 |
| (14.55%) | | | | | | | |
| | 100.00 | 100.00 | 100.00 | 100.00 | 100.00 | 100.00 | 100.00 |

Tested Before@110° F.

| | Ex 1 | Ex 2 | Ex 3 | Ex 4 | Ex 5 |
|---|---|---|---|---|---|
| pH of the Finished Formulation (Neat) | 13.52 | 13.43 | 13.33 | 13.19 | 12.56 |
| pH of the Wash Dilution Formulation (½ cup in 68 L water) | 11.89 | 11.82 | 11.69 | 11.55 | 11.3 |
| pH of the Wash Dilution Formulation (¾ cup in 68 L water) | 11.68 | 11.62 | 11.53 | 11.41 | 11.24 |
| Total Alkalinity | | | | | |
| Free Alkalinity | | | | | |

| | | | | | | | |
|---|---|---|---|---|---|---|---|
| Moles of Sulfamic | 0.0000 | 0.0976 | 0.0976 | 0.0976 | 0.0976 | 0.0976 | 0.0976 |
| Acid (97.10) | | | | | | | |
| Moles of Sodium | 0.0000 | 0.4375 | 0.2929 | 0.2441 | 0.1953 | 0.1465 | 0.0976 |
| Hydroxide (MW 39.9971) | | | | | | | |
| Excess NaOH (above | | 348 | 200 | 150 | 100 | 50 | 0.00 |
| sulfamic acid | | | | | | | |
| neutralization), % | | | | | | | |
| Moles of Sodium | 0.0940 | 0.0940 | 0.0940 | 0.0940 | 0.0940 | 0.0940 | 0.0940 |
| Hypochlorite (MW 74.442) | | | | | | | |

TABLE 6
Use of Sodium Monochloro(sodio) sulfamate

| | 7.36% Av Cl2 | | | | 3.68% Av Cl2 | | | |
|---|---|---|---|---|---|---|---|---|
| | 7.00% NaOCl | | | | 3.50% NaOCl | | | |
| | | Ex 88 | Ex 89 | Ex 90 | | Ex 91 | Ex 92 | Ex 93 |
| Ingredients | Control | Regular Bleach | | | Control | Regular Bleach | | |
| Water (Deionized) | 52.05 | 35.75 | 36.72 | 37.71 | 76.03 | 67.86 | 68.35 | 68.84 |
| Sodium Hydroxide (50%) | | 4.88 | 3.91 | 2.92 | | 2.46 | 1.97 | 1.48 |
| Sodium Sulfamate (98%) | | 11.42 | 11.42 | 11.42 | | 5.71 | 5.71 | 5.71 |
| Sodium Hypochlorite (14.6%)-Regular | 47.95 | 47.95 | 47.95 | 47.95 | 23.97 | 23.97 | 23.97 | 23.97 |
| | 100.00 | 100.00 | 100.00 | 100.00 | 100.00 | 100.00 | 100.00 | 100.00 |
| Moles of Sodium Sulfamate (119.07) | 0.000 | 0.094 | 0.094 | 0.094 | 0.000 | 0.047 | 0.047 | 0.047 |
| Moles of Sodium Hydroxide (MW 39.9971) | 0.000 | 0.061 | 0.049 | 0.037 | 0.000 | 0.031 | 0.025 | 0.019 |
| Moles of Sodium Hypochlorite (MW 74.442) | 0.094 | 0.094 | 0.094 | 0.094 | 0.047 | 0.047 | 0.047 | 0.047 |
| Molar Ratio of NaOH:NH₂SO₃Na | 0.000 | 0.649 | 0.520 | 0.388 | 0.000 | 0.654 | 0.524 | 0.394 |

TABLE 7
Formulations with Chelating Agents and Optical Brighteners

| | Compositions with Chelating Agents | | | | | | | | |
|---|---|---|---|---|---|---|---|---|---|
| | 6.30% Av Cl2 | | | | | | | | |
| | 6.00% NaOCl | | | | | | | | |
| | | | Ex 94 | Ex 95 | Ex 96 | Ex 97 | Ex 98 | Ex 99 | Ex 100 |
| Ingredients | Control 1 | Control 2 | Regular Bleach | | | | | | |
| Water (Deionized) | 58.90 | 36.30 | 36.17 | 36.34 | 36.30 | 36.77 | 36.12 | 35.50 | 37.30 |
| Sodium Hydroxide (50%) | 0.00 | 13.40 | 13.40 | 13.40 | 13.40 | 13.40 | 13.40 | 13.40 | 13.40 |
| Sulfamic Acid (99%) | 0.00 | 8.20 | 8.20 | 8.20 | 8.20 | 8.20 | 8.20 | 8.20 | 8.20 |
| Sodium Hypochlorite (12.55%) | 41.10 | 41.10 | 41.10 | 41.10 | 41.10 | 41.10 | 41.10 | 41.10 | 41.10 |
| Chelating Agents/Optical | 0.00 | | | | | | | | |
| Brightener | | | | | | | | | |
| NaPolyacrylate-Accusol ™ | | 1.00 | | | | | | | |
| 445 N 45%) | | | | | | | | | |
| Na3Methyl Glycine Diacetate- | | | 1.13 | | | | | | |
| Trilon ® M Liquid (40%) | | | | | | | | | |
| Na4Glutamic Acid Diacetate- | | | | 0.96 | | | | | |
| Dissolvine ® GL47S (47%) | | | | | | | | | |
| Hybrid Bio Polymer-AlcoGuard ® | | | | | 1.00 | | | | |
| HS 5240 (45%) | | | | | | | | | |
| NaPolyitaconate- Itaconix ™ | | | | | | 0.53 | | | |
| DSP2K- US (85%) | | | | | | | | | |
| NaₓCarboxy Methyl Inulin- | | | | | | | 1.18 | | |
| Cosun ™ CMI 25-40D (38%) | | | | | | | | | |
| NaₓCarboxy Methyl Inulin- | | | | | | | | 1.80 | |
| Dequest ® SPE 15625 (25%) | | | | | | | | | |
| Tinosorb ™ FB (Ciba) | | | | | | | | | 0.25 |
| | 100.00 | 100.00 | 100.00 | 100.00 | 100.00 | 100.00 | 100.00 | 100.00 | 100.00 |
| Moles of Sulfamic Acid (97.10) | 0.0000 | 0.0836 | 0.0836 | 0.0836 | 0.0836 | 0.0836 | 0.0836 | 0.0836 | 0.0836 |
| Moles of Sodium Hydroxide | 0.0000 | 0.1675 | 0.1675 | 0.1675 | 0.1675 | 0.1675 | 0.1675 | 0.1675 | 0.1675 |
| (MW 39.9971) | | | | | | | | | |
| Excess NaOH (above sulfamic | 0.0000 | 2.000 | 2.000 | 2.000 | 2.000 | 2.000 | 2.000 | 2.000 | 2.000 |
| acid neutralization), | | | | | | | | | |
| Moles of Sodium Hypochlorite | 0.0940 | 0.0940 | 0.0940 | 0.0940 | 0.0940 | 0.0940 | 0.0940 | 0.0940 | 0.0940 |
| (MW 74.442) | | | | | | | | | |
| | Compositions with Chelating Agents | | | | | | | | |
| | 6.30% Av Cl2 | | | | | | | | |
| | 6.00% NaOCl | | | | | | | | |
| | | | Ex 101 | Ex 102 | Ex 103 | Ex 104 | Ex 105 | Ex 106 | Ex 107 |
| Ingredients | Control 1 | Control 2 | Regular Bleach | | | | | | |
| Water (Deionized) | 58.90 | 39.68 | 39.55 | 39.72 | −162.55 | 40.15 | 39.50 | 38.88 | 40.68 |
| Sodium Hydroxide (50%) | 0.00 | 10.02 | 10.02 | 10.02 | 10.02 | 10.02 | 10.02 | 10.02 | 10.02 |
| Sulfamic Acid (99%) | 0.00 | 8.2 | 8.2 | 8.20 | 8.20 | 8.20 | 8.20 | 8.20 | 8.20 |
| Sodium Hypochlorite (12.55%) | 41.10 | 41.10 | 41.10 | 41.10 | 243.33 | 41.10 | 41.10 | 41.10 | 41.10 |
| Chelating Agents/Optical | 0.00 | | | | | | | | |
| Brightener | | | | | | | | | |
| NaPolyacrylate-Accusol ™ | | 1.00 | | | | | | | |
| 445 N 45%) | | | | | | | | | |
| Na3Methyl Glycine Diacetate- | | | 1.13 | | | | | | |
| Trilon ® M Liquid (40%) | | | | | | | | | |
| Na4Glutamic Acid Diacetate- | | | | 0.96 | | | | | |
| Dissolvine ® GL47S (47%) | | | | | | | | | |
| Hybrid Bio Polymer-AlcoGuard ® | | | | | 1.00 | | | | |
| HS 5240 (45%) | | | | | | | | | |
| NaPolyitaconate- Itaconix ™ | | | | | | 0.53 | | | |
| DSP2K- US (85%) | | | | | | | | | |
| NaₓCarboxy Methyl Inulin- | | | | | | | 1.18 | | |
| Cosun ™ CMI 25-40D (38%) | | | | | | | | | |
| NaₓCarboxy Methyl Inulin- | | | | | | | | 1.80 | |
| Dequest ® SPE 15625 (25%) | | | | | | | | | |
| Tinosorb ™ FB (Ciba) | | | | | | | | | 0.25 |
| | 100.00 | 100.00 | 100.00 | 100.00 | 100.00 | 100.00 | 100.00 | 100.00 | 100.00 |
| Moles of Sulfamic Acid (97.10) | 0.0836 | 0.0836 | 0.0836 | 0.0836 | 0.0836 | 0.0836 | 0.0836 | 0.0836 | 0.0836 |
| Moles of Sodium Hydroxide | 0.000 | 0.1253 | 0.1253 | 0.1253 | 0.1253 | 0.1253 | 0.1253 | 0.1253 | 0.1253 |
| (MW 39.9971) | | | | | | | | | |
| Excess NaOH (above sulfamic | 0.000 | 1.000 | 1.000 | 1.000 | 1.000 | 1.000 | 1.000 | 1.000 | 1.000 |
| acid neutralization), | | | | | | | | | |
| Moles of Sodium Hypochlorite | 0.0940 | 0.0940 | 0.0940 | 0.0940 | 0.0940 | 0.0940 | 0.0940 | 0.0940 | 0.0940 |
| (MW 74.442) | | | | | | | | | |

TABLE 8
Sodium Hypochlorite Stability at 100° F.: 4.0 and 7.0% NaOCl

| | RemainingHypochlorite, % | | | |
|---|---|---|---|---|
| | 7.0% Hypochlorite | | 4.0% Hypochlorite | |
| | NoStabilizer/ | Stabilized/ | NoStabilizer/ | Stabilized/ |
| Days | Control | ClN(Na)SO₃Na | Control | ClN(Na)SO₃Na |
| 122 | 40 | 91 | | |
| 118 | | | 5 | 85 |

FIGS. 1 and 2 plot more detailed stability data for exemplary sodium monochloro (sodio) sulfamate compositions as compared to standard aqueous hypochlorite compositions and for stabilized aqueous hypochlorite compositions stabilized with sodium polyacrylate. Additional stability data is also presented below in Tables 9 and 10.

TABLE 9
Sodium Hypochlorite Stability at 100° F.: 4.0, 3.5 & 3.0% NaOCl

| | 4.00% NaOCl: NaOCl % Remaining | | | | 3.50% NaOCl: NaOCl % Remaining | | | 3.00% NaOCl: NaOCl % Remaining | | |
|---|---|---|---|---|---|---|---|---|---|---|
| | Reg 4% | Stab 4% | Stab 4% | Stab 4% | Stab 3.5% | Stab 3.5% | Stab 3.5% | Stab 3% | Stab 3% | Stab 3% |
| | Hypo | Hypo-HA | Hypo-HA | Hypo-LA | Hypo-HA | Hypo-MA | Hypo-LA | Hypo-HA | Hypo-MA | Hypo-LA |
| | No | 17.5% | 17.5% | 12.5% | 15.3% | 13.3% | 10.9% | 13.5% | 11.0% | 9.9% |
| Days | Stabilizer | NaOH/PA | NaOH | NaOH | NaOH | NaOH | NaOH | NaOH | NaOH | NaOH |
| 1 | 100 | 100 | 100 | 100 | 100 | 100 | 100 | 100 | 100 | 100 |
| 6 | 98 | 97 | 98 | 98 | 97 | 98 | 98 | 97 | 98 | 93 |
| 17 | 92 | 95 | 96 | 97 | 96 | 97 | 96 | 97 | 97 | 96 |
| 24 | 88 | 95 | 96 | 94 | 96 | 95 | 6 | 96 | 95 | 94 |
| 28 | 86 | 94 | 96 | 94 | 95 | 95 | 95 | 96 | 95 | 94 |
| 35 | 82 | 93 | 94 | 95 | 94 | 95 | 94 | 95 | 95 | 93 |
| 42 | 79 | 92 | 94 | 95 | 94 | 95 | 94 | 94 | 93 | 92 |
| 49 | 75 | 91 | 93 | 94 | 93 | 94 | 97 | 97 | 92 | 91 |
| 56 | 72 | 91 | 93 | 94 | 93 | 93 | 92 | 93 | 92 | 90 |
| 66 | 68 | 88 | 90 | 92 | 90 | 91 | 90 | 91 | 90 | 88 |
| 80 | 61 | 86 | 88 | 89 | 89 | 89 | 88 | 88 | 87 | 84 |
| 98 | 29 | 84 | 86 | 87 | 87 | 88 | 86 | 87 | 85 | 87 |
| 110 | 11 | 83 | 86 | 87 | 86 | 87 | 85 | 87 | 85 | 83 |
| 118 | 5 | 82 | 85 | 84 | 86 | 86 | 85 | 86 | 84 | 82 |

TABLE 10
Sodium Hypochlorite Stability at 100° F.: 5.0, 6.0 & 7.0% NaOCl

| | 7.00% NaOCl: NaOCl % Remaining | | | | 6.00% NaOCl: NaOCl % Remaining | | | 5.00% NaOCl: NaOCl % Remaining | | |
|---|---|---|---|---|---|---|---|---|---|---|
| | Reg 7% | Stab 7% | Stab 7% | Stab 7% | Stab 6% | Stab 6% | Stab 6% | Stab 5% | Stab 5% | Stab 5% |
| | Hypo | Hypo-HA | Hypo-MA | Hypo-LA | Hypo-HA | Hypo-MA | Hypo-LA | Hypo-HA | Hypo-MA | Hypo-LA |
| | No | 17.5% | 15.0% | 12.5% | 15.0% | 12.5% | 10.0% | 12.5% | 10.0% | 7.5% |
| Days | Stabilizer | NaOH | NaOH | NaOH | NaOH | NaOH | NaOH | NaOH | NaOH | NaOH |
| 1 | 100 | 100 | 100 | 100 | 100 | 100 | 100 | 100 | 100 | 100 |
| 7 | 92 | 100 | 100 | 100 | 98 | 100 | 96 | 100 | 100 | 99 |
| 14 | 84 | 92 | 99 | 99 | 98 | 98 | 95 | 99 | 99 | 99 |
| 21 | 79 | 93 | 98 | 99 | 97 | 98 | 94 | 98 | 98 | 97 |
| 28 | 75 | 93 | 99 | 98 | 97 | 98 | 94 | 98 | 98 | 96 |
| 38 | 68 | 96 | 97 | 97 | 96 | 97 | 92 | 96 | 96 | 94 |
| 52 | 60 | 94 | 95 | 96 | 94 | 95 | 90 | 95 | 93 | 91 |
| 70 | 50 | 93 | 94 | 94 | 94 | 93 | 89 | 93 | 92 | 88 |
| 81 | 48 | 92 | 93 | 94 | 94 | 93 | 90 | 93 | 93 | 88 |
| 90 | 46 | 91 | 92 | 93 | 93 | 92 | 87 | 92 | 91 | 87 |
| 97 | 43 | 91 | 92 | 92 | 92 | 92 | 87 | 91 | 90 | 86 |
| 112 | 40 | 90 | 91 | 91 | 90 | 90 | 86 | 91 | 89 | 85 |

TABLE 11
Stabilized Alkaline NaOCl Releasing Bleaches with Sodium Monochloro(sodio) Sulfamate

| | 4.20% Av Cl2 | | | | 3.68% Av Cl2 |
|---|---|---|---|---|---|
| | 4.00% NaOCl | | | | 3.50% NaOCl |
| Ingredients | Control | Ex 108 | Ex 109 | Ex 110 | Ex 111 |
| Water (Deionized) | 70.70 | 28.23 | 30.23 | 40.23 | 39.01 |
| Sodium Polyacrylate (50%)- | 0.00 | 2.00 | 0.00 | 0.00 | 0.00 |
| Accusol ™ | | | | | |
| Phosphonobutanetricarboxy | 0.00 | 0.00 | 0.00 | 0.00 | 0.00 |
| Acid (50%) | | | | | |
| Sodium Hydroxide (50%) | 0.00 | 35.00 | 35.00 | 25.00 | 30.60 |
| Sulfamic Acid | 0.00 | 5.47 | 5.47 | 5.47 | 4.79 |
| Sodium Hypochlorite (13.66%) | 29.30 | 29.30 | 29.30 | 29.30 | 25.60 |
| | 100.00 | 100.00 | 100.00 | 100.00 | 100.00 |

| | | |
|---|---|---|
| Chemical Stability | Control | Control with Sulfamic Acid added in the Formula |

pH (Neat)

| | | | | | |
|---|---|---|---|---|---|
| TOM (1 Days) | 12.32 | 13.48 | 13.63 | 13.58 | 13.82 |
| Hot Temp, 100° F./38° C.; (6 Days) | 12.15 | 13.95 | 14.20 | 14.23 | 14.09 |
| (17 Days) | 11.91 | 14.10 | 13.99 | 13.93 | 13.84 |
| (24 days) | 11.97 | 13.77 | 14.12 | 14.07 | 14.10 |
| (28 days) | 13.59 | 13.40 | 13.07 | 12.99 | 12.96 |
| (35 Days) | 11.79 | 14.04 | 13.94 | 13.73 | 13.71 |
| (42 Days) | 11.75 | 13.59 | 13.57 | 13.54 | 13.55 |
| (49 Days) | 11.79 | 13.48 | 13.46 | 13.39 | 13.39 |
| (56 Days) | 11.38 | 13.22 | 13.14 | 13.16 | 13.18 |
| (66 Days) | 11.14 | 13.49 | 13.44 | 13.38 | 13.16 |
| (98 Days) | 9.10 | 13.90 | 13.88 | 13.86 | 13.85 |
| (110 days) | 8.64 | 13.65 | 13.70 | 13.67 | 13.69 |
| (118 days) | 8.40 | 13.40 | 13.28 | 13.26 | 13.35 |

Alkalinity (NaOH) %

| | | | | | |
|---|---|---|---|---|---|
| TOM (1 Days) | −0.169 | 14.035 | 15.052 | 10.046 | 12.173 |
| Hot Temp, 100° F./38° C.; (6 Days) | −0.16 | 15.612 | 15.081 | 11.09 | 13.351 |
| (17 Days) | −0.169 | 15.646 | 15.396 | 11.165 | 13.872 |
| (28 days) | −0.169 | 15.494 | 15.642 | 11.213 | 13.679 |
| (35 Days) | −0.181 | 15.488 | 15.346 | 11.249 | 13.252 |
| (42 Days) | −0.184 | 15.208 | 15.618 | 11.032 | 13.826 |
| (49 Days) | −0.109 | 15.587 | 15.864 | 11.126 | 14.001 |
| (56 Days) | −0.2 | 16.024 | 15.642 | 11.345 | 13.93 |
| (66 Days) | −0.212 | 15.162 | 15.362 | 10.95 | 15.789 |
| (80 Days) | −0.225 | 15.036 | 15.160 | 10.84 | 13.364 |
| (98 Days) | −0.298 | 15.144 | 15.422 | 11.133 | 13.457 |
| (110 days) | −0.068 | 3.217 | 3.274 | 3.302 | 2.849 |
| (118 days) | −0.351 | 15.579 | 14.524 | 11.273 | 13.788 |

Sodium Carbonate %

| | | | | | |
|---|---|---|---|---|---|
| TOM (1 Days) | 0.6870 | 1.4210 | 1.3610 | 2.0490 | 0.8490 |
| Hot Temp, 100° F./38° C.; (6 Days) | 0.684 | 1.810 | 1.101 | 0.842 | 1.234 |
| (17 Days) | 0.659 | 1.814 | 1.110 | 1.124 | 1.368 |
| (24 days) | 0.664 | 1.856 | 1.371 | 0.96 | 0.211 |
| (35 Days) | 0.683 | 1.741 | 1.088 | 0.951 | 1.028 |
| (42 Days) | 0.682 | 1.732 | 1.034 | 0.915 | 1.009 |
| (49 Days) | 0.703 | 1.669 | 1.128 | 0.75 | 1.0061 |
| (56 Days) | 0.703 | 1.693 | 1.4 | 1.064 | 1.05 |
| (66 Days) | 0.720 | 1.656 | 1.094 | 0.912 | 1.2232 |
| (80 Days) | 0.729 | 1.749 | 1.065 | 1.02 | 1.079 |
| (98 Days) | 0.878 | 1.562 | 1.113 | 0.779 | 0.967 |
| (110 days) | 0.194 | 0.258 | 0.126 | 0.109 | 0.172 |
| (118 days) | 0.986 | 2.090 | 1.47 | 1.277 | 1.045 |

Sodium Hypochlorite %

| TOM (1 Days) | 4.04 | 4.03 | 4.06 | 4.03 | 3.51 |
|---|---|---|---|---|---|
| Hot Temp, 100° F./38° C.; (6 Days) | 3.97 (−1.7%) | 3.92 (−2.7%) | 3.96 (−2.5%) | 3.95 (−1.7%) | 3.42 (−2.6%) |
| (17 Days) | 3.72 (−8.0%) | 3.83 (−5.0%) | 3.90 (−3.7%) | 3.91 (−3.1%) | 3.38 (−3.7%) |
| (24 days) | 3.57 (−11.7%) | 3.81 (−5.5%) | 3.88 (−4.4%) | 3.89 (−3.6%) | 3.36 (−4.2%) |
| (28 days) | 3.48 (−13.9%) | 3.79 (−5.9%) | 3.88 (−4.3%) | 3.88 (−3.7%) | 3.35 (−4.6%) |
| (35 Days) | 3.33 (−17.7%) | 3.75 (−7.0%) | 3.84 (−5.5%) | 3.84 (−4.8%) | 3.31 (−5.6%) |
| (42 Days) | 3.18 (−21.4%) | 3.73 (−7.54%) | 3.82 (−5.9%) | 3.85 (−4.5%) | 3.30 (−6.0%) |
| (49 Days) | 3.20 (−25.3%) | 3.66 (−9.1%) | 3.77 (−7.3%) | 3.79 (−5.6%) | 3.26 (−7.1%) |
| (56 Days) | 2.91 (−28.0%) | 3.67 (−8.9%) | 3.79 (−6.8%) | 3.78 (−6.3%) | 3.26 (−7.2%) |
| (66 Days) | 2.77 (−31.5%) | 3.56 (−11.7%) | 3.67 (−9.7%) | 3.69 (−8.4%) | 3.17 (−9.7%) |
| (80 Days) | 2.49 (−38.5%) | 3.45 (−14.4%) | 3.57 (−12.1%) | 3.58 (−11.2%) | 3.12 (−11.1%) |
| (98 Days) | 1.18 (−70.8%) | 3.37 (−16.4%) | 3.51 (−13.6%) | 3.51 (−12.9%) | 3.06 (−12.8%) |
| (110 days) | 0.44 (−89.2%) | 3.35 (−16.9%) | 3.50 (−13.8%) | 3.52 (−12.7%) | 3.04 (−13.5%) |
| (118 days) | 0.22 (−94.5%) | 3.31 (−17.9%) | 3.47 (−14.5%) | 3.38 (−16.1%) | 3.01 (−14.2%) |
| | 3.68% Av Cl2 | | 3.15% Av Cl2 | | |
| | 3.50% NaOCl | | 3.00% NaOCl | | |
| Ingredients | Ex 112 | Ex 113 | Ex 114 | Ex 115 | Ex 116 |
| Water (Deionized) | 43.31 | 47.71 | 69.60 | 51.90 | 55.10 |
| Sodium Polyacrylate (50%)- | 0.00 | 0.00 | 0.00 | 0.00 | 0.00 |
| Accusol ™ | | | | | |
| Phosphonobutanetricarboxy | 0.00 | 0.00 | 0.00 | 0.00 | 0.00 |
| Acid (50%) | | | | | |
| Sodium Hydroxide (50%) | 26.30 | 21.90 | 26.30 | 22.00 | 18.80 |
| Sulfamic Acid | 4.79 | 4.79 | 4.10 | 4.10 | 4.10 |
| Sodium Hypochlorite (13.66%) | 25.60 | 25.60 | 22.00 | 22.00 | 22.00 |
| | 100.00 | 100.00 | 100.00 | 100.00 | 100.00 |

| | |
|---|---|
| Chemical Stability | Control with Sulfamic Acid added in the Formula |

pH (Neat)

| | | | | | |
|---|---|---|---|---|---|
| TOM (1 Days) | 13.73 | 13.58 | 13.57 | 13.45 | 13.43 |
| Hot Temp, 100° F./38° C.; (6 Days) | 14.00 | 14.02 | 13.98 | 13.96 | 13.96 |
| (17 Days) | 13.54 | 13.45 | 13.43 | 13.43 | 13.43 |
| (24 days) | 14.14 | 13.93 | 13.91 | 13.73 | 13.44 |
| (28 days) | 12.99 | 12.91 | 12.92 | 12.97 | 12.93 |
| (35 Days) | 13.62 | 13.39 | 13.39 | 13.34 | 13.27 |
| (42 Days) | 13.52 | 13.49 | 13.51 | 13.48 | 13.42 |
| (49 Days) | 13.39 | 13.38 | 13.42 | 13.36 | |
| (56 Days) | 13.12 | 13.02 | 13.07 | 13.14 | 13.15 |
| (66 Days) | 13.10 | 13.05 | 13.08 | 13.08 | 13.02 |
| (98 Days) | 13.84 | 13.78 | 13.85 | 13.82 | 13.75 |
| (110 days) | 13.67 | 13.63 | 13.65 | 13.60 | 13.55 |
| (118 days) | 13.22 | 13.18 | 13.22 | 13.18 | 13.11 |

Alkalinity (NaOH) %

| | | | | | |
|---|---|---|---|---|---|
| TOM (1 Days) | 11.695 | 9.369 | 10.697 | 8.217 | 8.109 |
| Hot Temp, 100° F./38° C.; (6 Days) | 11.024 | 9.378 | 11.392 | 9.305 | 8.037 |
| (17 Days) | 11.806 | 9.81 | 11.64 | 9.683 | 8.181 |
| (28 days) | 11.571 | 9.723 | 11.679 | 9.491 | 8.239 |
| (35 Days) | 11.909 | 9.954 | 12.091 | 10.04 | 8.465 |
| (42 Days) | 11.359 | 9.673 | 11.845 | 9.899 | 8.328 |
| (49 Days) | 11.784 | 9.846 | 11.472 | 9.872 | 8.349 |
| (56 Days) | 11.842 | 9.867 | 11.812 | 9.815 | 8.287 |
| (66 Days) | 11.106 | 9.653 | 11.523 | 9.536 | 8.068 |
| (80 Days) | 11.325 | 9.818 | 11.543 | 9.36 | 7.956 |
| (98 Days) | 11.74 | 9.63 | 11.678 | 9.638 | 8.361 |
| (110 days) | 2.443 | 2.022 | 2.447 | 2.026 | 1.696 |
| (118 days) | 11.646 | 9.12 | 11.498 | 9.317 | 7.791 |

Sodium Carbonate %

| | | | | | |
|---|---|---|---|---|---|
| TOM (1 Days) | 0.8290 | 1.3980 | 1.8410 | 2.7670 | 1.1800 |
| Hot Temp, 100° F./38° C.; (6 Days) | 1.527 | 1.355 | 1.270 | 1.560 | 1.213 |
| (17 Days) | 1.316 | 0.947 | 1.524 | 1.226 | 1.247 |
| (24 days) | 0.997 | 0.969 | 1.069 | 1.069 | 0.958 |
| (35 Days) | 1.303 | 0.914 | 1.184 | 0.972 | 0.917 |
| (42 Days) | 1.006 | 0.87 | 0.899 | 0.903 | 0.858 |
| (49 Days) | 0.899 | 0.864 | 0.887 | 0.827 | 0.782 |
| (56 Days) | 1.009 | 0.825 | 1.111 | 0.911 | 0.78 |
| (66 Days) | 1.302 | 0.887 | 1.063 | 0.978 | 0.854 |
| (80 Days) | 1.209 | 1.034 | 1.103 | 1.013 | 0.933 |
| (98 Days) | 1.039 | 0.875 | 0.976 | 8.75 | 0.732 |
| (110 days) | 0.109 | 0.139 | 0.105 | 0.093 | 0.099 |
| (118 days) | 1.114 | 1.64 | 1.73 | 1.421 | 1.524 |

Sodium Hypochlorite %

| | | | | | |
|---|---|---|---|---|---|
| TOM (1 Days) | 3.53 | 3.56 | 3.04 | 3.00 | 3.04 |
| Hot Temp, 100° F./38° C.; (6 Days) | 3.46 (−2.0%) | 3.46 (−2.8%) | 2.97 (−2.3% | 2.93 (−2.3%) | 2.95 (−2.9%) |
| (17 Days) | 3.42 (−3.1%) | 3.43 (−3.6%) | 2.95 (−3.1%) | 2.91 (−3.0%) | 2.91 (−4.3%) |
| (24 days) | 3.36 (−4.7%) | 3.41 (−4.1%) | 2.92 (−4.1%) | 2.86 (−4.7%) | 2.87 (−5.5%) |
| (28 days) | 3.37 (−4.5%) | 3.37 (−5.3%) | 2.91 (−4.3%) | 2.85 (−5.0%) | 2.84 (−6.4%) |
| (35 Days) | 3.36 (−4.8%) | 3.36 (−5.6%) | 2.88 (−5.4%) | 2.85 (−5.2%) | 2.82 (−7.3%) |
| (42 Days) | 3.37 (−4.6%) | 3.35 (−6.0%) | 2.87 (−5.6%) | 2.81 (−6.5%) | 2.81 (−7.7%) |
| (49 Days) | 3.31 (−6.3%) | 3.46 (−2.9%) | 2.96 (−2.8%) | 2.77 (−7.6%) | 2.77 (−8.9%) |
| (56 Days) | 3.30 (−6.5%) | 3.29 (−7.6%) | 2.82 (−7.3%) | 2.75 (−8.3%) | 2.74 (−9.9%) |
| (66 Days) | 3.21 (−9.2%) | 3.20 (−10.1%) | 2.78 (−8.7%) | 2.69 (−10.3%) | 2.68 (−11.8%) |
| (80 Days) | 3.14 (−10.9%) | 3.14 (−11.8%) | 2.67 (−12.2%) | 2.62 (−12.8%) | 2.56 (−15.7%) |
| (98 Days) | 3.09 (−12.3%) | 3.05 (−14.3%) | 2.65 (−12.9%) | 2.55 (−14.9%) | 2.66 (−12.6%) |
| (110 days) | 3.07 (−13.1%) | 3.04 (−14.7%) | 2.64 (−13.1%) | 2.56 (−14.5%) | 2.52 (−17.1%) |
| (118 days) | 3.04 (−13.9%) | 3.02 (−15.3%) | 2.60 (−14.4%) | 2.51 (−16.2%) | 2.49 (−18.2%) |

TABLE 12
Stabilized Alkaline NaOCl Releasing Bleaches with Sodium Monochloro(sodio) Sulfamate

| | 7.36% Av Cl₂ | | | | 6.31% Av Cl₂ |
|---|---|---|---|---|---|
| | 7.00% NaOCl | | | | 6.00% NaOCl |
| Ingredients | Control | Ex 117 | Ex 118 | Ex 119 | Ex 120 |
| Water (Deionized) | 48.75 | 4.18 | 9.18 | 14.18 | 17.86 |
| Sodium Polyacrylate (50%)- | 0.00 | 0.00 | 0.00 | 0.00 | 0.00 |
| Accusol ™ 445N | | | | | |
| Phosphonobutanetricarboxy Acid (50%) | 0.00 | 0.00 | 0.00 | 0.00 | 0.00 |
| Sodium Hydroxide (50%) | 0.00 | 35.00 | 30.00 | 25.00 | 30.00 |
| Sulfamic Acid | 0.00 | 9.57 | 9.57 | 9.57 | 8.21 |
| Sodium Hypochlorite (13.66%) | 51.25 | 51.25 | 51.25 | 51.25 | 43.93 |
| | 100.00 | 100.00 | 100.00 | 100.00 | 100.00 |
| Moles of Sulfamic Acid (97.10) | | 0.10 | 0.10 | 0.10 | 0.08 |
| Moles of Sodium Hydroxide (MW 39.9971) | | 0.44 | 0.38 | 0.31 | 0.38 |
| Moles of Sodium Hypochlorite (MW 74.442) | | 0.09 | 0.09 | 0.09 | 0.08 |

| | | |
|---|---|---|
| Chemical Stability | Control | Control with Sulfamic Acid added in the Formula |

pH (Neat)

| | | | | | |
|---|---|---|---|---|---|
| TOM | 12.47 | 13.67 | 13.69 | 13.53 | 13.61 |
| Hot Temp (100° F./38° C.), (7 Days) | 11.95 | 13.10 | 13.19 | 13.13 | 13.26 |
| (14 Days) | 12.34 | 13.66 | 13.69 | 13.62 | 13.61 |
| (21 Days) | 12.31 | 13.63 | 13.84 | 13.90 | 13.85 |
| (28 Days) | 12.25 | 13.60 | 13.58 | 13.51 | 13.42 |
| (38 Days) | 11.72 | 12.95 | 13.32 | 12.97 | 12.93 |
| (52 Days) | 12.15 | 13.63 | 13.64 | 13.61 | 13.63 |
| (70 Days) | 12.19 | 13.81 | 13.85 | 13.82 | 13.87 |
| (81 Days) | 12.18 | 14.00 | 13.93 | 13.92 | 13.97 |
| (90 Days) | 11.98 | 13.46 | 13.47 | 13.39 | 13.45 |
| (97 Days) | 11.89 | 13.29 | 13.25 | 13.23 | 13.27 |
| (112 Days) | 11.63 | 13.12 | 13.15 | 13.16 | 13.12 |

Alkalinity (NaOH) %

| | | | | | |
|---|---|---|---|---|---|
| TOM | 0.126 | 14.439 | 12.999 | 9.905 | 12.599 |
| Hot Temp (100° F./38° C.), (7 Days) | 0.120 | 15.862 | 13.503 | 10.938 | 13.421 |
| (14 Days) | 0.117 | 14.402 | 12.402 | 10.031 | 12.787 |
| (21 Days) | 0.115 | 13.118 | 12.761 | 10.571 | 13.107 |
| (28 Days) | 0.11 | 14.789 | 12.645 | 9.586 | 12.883 |
| (38 Days) | 0.097 | 14.611 | 12.879 | 9.763 | 14.312 |
| (45 days) | 0.092 | 13.148 | 11.013 | 9.113 | 11.309 |
| (52 Days) | 0.094 | 12.84 | 11.493 | 9.892 | 12.132 |
| (70 Days) | 0.083 | 12.987 | 10.825 | 10.027 | 11.991 |
| (81 Days) | 0.0073 | 13.582 | 12.831 | 10.551 | 12.671 |
| (90 Days) | 0.062 | 14.8 | 13.042 | 10.5 | 12.684 |
| (97 Days) | 0.051 | 15.374 | 13.147 | 10.834 | 13.26 |
| (112 Days) | 0.02 | 15.331 | 13.046 | 10.664 | 12.691 |

Sodium Carbonate %

| | | | | | |
|---|---|---|---|---|---|
| TOM | 0.052 | 0.936 | 0.93 | 0.907 | 0.84 |
| Hot Temp (100° F./38° C.), (7 Days) | 0.061 | 1.335 | 1.125 | 1.399 | 1.523 |
| (14 Days) | 0.066 | 1.078 | 0.84 | 0.972 | 1.037 |
| (21 Days) | 0.067 | 0.877 | 1.014 | 1.024 | 0.965 |
| (28 Days) | 0.074 | 1.06 | 0.964 | 1.125 | 0.929 |
| (38 Days) | 0.088 | 1.251 | 0.938 | 0.895 | 1.16 |
| (45 days) | 0.092 | 0.917 | 0.737 | 0.658 | 0.712 |
| (52 Days) | 0.094 | 0.767 | 0.881 | 0.946 | 1.156 |
| (70 Days) | 0.11 | 0.716 | 0.656 | 0.749 | 0.812 |
| (81 Days) | 0.125 | 0.842 | 0.959 | 0.943 | 0.837 |
| (90 Days) | 0.141 | 0.911 | 0.872 | 0.9 | 0.929 |
| (97 Days) | 0.155 | 1.384 | 1.307 | 1.229 | 1.487 |
| (112 Days) | 0.189 | 1.212 | 1.182 | 1.283 | 0.867 |

Sodium Hypochlorite %

| TOM | 6.97 | 6.91 | 6.88 | 6.85 | 5.96 |
|---|---|---|---|---|---|
| Hot Temp (100° F./38° C.), (7 Days) | 6.44 (−7.6%) | 6.89 (−0.2%) | 6.87 (−0.2%) | 6.91 (−0.1%) | 5.86 (−1.7%) |
| (14 Days) | 5.97 (−14.4%) | 6.78 (−1.9%) | 6.85 (−0.5%) | 6.8 (−0.8%) | 5.85 (−1.8%) |
| (21 Days) | 5.53 (−20.7%) | 6.73 (−2.7%) | 6.75 (−1.9%) | 6.76 (−1.3%) | 5.8 (−2.8%) |
| (28 Days) | 5.22 (−25.1%) | 6.72 (−2.7%) | 6.79 (−1.3%) | 6.73 (−1.7%) | 5.78 (−3.0%) |
| (38 Days) | 4.72 (−32.3%) | 6.64 (−3.8%) | 6.68 (−2.9%) | 6.68 (−2.5%) | 5.73 (−3.9%) |
| (52 Days) | 4.16 (−40.3%) | 6.48 (−6.3%) | 6.55 (−4.8%) | 6.55 (−4.3%) | 5.61 (−5.9%) |
| (70 Days) | 3.49 (−49.9%) | 6.42 (−7.1%) | 6.48 (−5.8%) | 6.44 (−6.0%) | 5.54 (−7.1%) |
| (81 Days) | 3.36 (−51.9%) | 6.35 (−8.1%) | 6.42 (−6.7%) | 6.43 (−6.2%) | 5.51 (−7.5%) |
| (90 Days) | 3.18 (−54.4%) | 6.32 (−8.5%) | 6.36 (−7.5%) | 6.38 (−6.9%) | 5.47 (−8.3%) |
| (97 Days) | 3.02 (−56.7%) | 6.30 (−8.8%) | 6.37 (−7.4%) | 6.32 (−7.7%) | 5.43 (−8.9%) |
| (112 Days) | 2.77 (−60.3%) | 6.19 (−10.4%) | 6.27 (−8.8%) | 6.26 (−8.6%) | 5.35 (−10.2%) |

| | 6.31% Av Cl₂ | | 5.26% Av Cl₂ | | |
|---|---|---|---|---|---|
| | 6.00% NaOCl | | 5.00% NaOCl | | |
| Ingredients | Ex 121 | Ex 122 | Ex 123 | Ex 124 | Ex 125 |
| Water (Deionized) | 22.86 | 27.86 | 31.55 | 34.55 | 41.55 |
| Sodium Polyacrylate (50%)- | 0.00 | 0.00 | 0.00 | 0.00 | 0.00 |
| Accusol ™ 445N | | | | | |
| Phosphonobutanetricarboxy Acid (50%) | 0.00 | 0.00 | 0.00 | 0.00 | 0.00 |
| Sodium Hydroxide (50%) | 25.00 | 20.00 | 25.00 | 20.00 | 15.00 |
| Sulfamic Acid | 8.21 | 8.21 | 6.84 | 8.84 | 6.84 |
| Sodium Hypochlorite (13.66%) | 43.93 | 43.93 | 36.61 | 36.61 | 36.61 |
| | 100.00 | 100.00 | 100.00 | 100.00 | 100.00 |
| Moles of Sulfamic Acid (97.10) | 0.08 | 0.08 | 0.07 | 0.07 | 0.07 |
| Moles of Sodium Hydroxide (MW 39.9971) | 0.31 | 0.25 | 0.31 | 0.25 | 0.19 |
| Moles of Sodium Hypochlorite (MW 74.442) | 0.08 | 0.08 | 0.07 | 0.07 | 0.07 |

| | |
|---|---|
| Chemical Stability | Control with Sulfamic Acid added in the Formula |

pH (Neat)

| | | | | | |
|---|---|---|---|---|---|
| TOM | 13.58 | 13.48 | 13.57 | 13.48 | 13.32 |
| Hot Temp (100° F./38° C.), (7 Days) | 13.2 | 13.09 | 13.11 | 13.08 | 13.11 |
| (14 Days) | 13.59 | 13.48 | 13.61 | 13.57 | 13.47 |
| (21 Days) | 13.82 | 13.73 | 13.77 | 13.57 | 13.49 |
| (28 Days) | 13.51 | 13.32 | 13.11 | 13.01 | 12.95 |
| (38 Days) | 12.91 | 12.85 | 12.94 | 12.9 | 12.85 |
| (52 Days) | 13.71 | 13.66 | 13.75 | 13.69 | 13.58 |
| (70 Days) | 13.84 | 13.83 | 13.89 | 13.81 | 13.68 |
| (81 Days) | 13.91 | 13.78 | 13.85 | 13.78 | 13.62 |
| (90 Days) | 13.39 | 13.34 | 13.47 | 13.38 | 13.26 |
| (97 Days) | 13.17 | 13.07 | 13.13 | 13.06 | 12.96 |
| (112 Days) | 13.11 | 13.05 | 13.07 | 13.05 | 12.97 |

Alkalinity (NaOH) %

| | | | | | |
|---|---|---|---|---|---|
| TOM | 10.676 | 8.14 | 10.623 | 8.626 | 6.765 |
| Hot Temp (100° F./38° C.), (7 Days) | 10.965 | 8.481 | 11.052 | 10.005 | 7.269 |
| (14 Days) | 10.203 | 7.731 | 10.48 | 8.84 | 5.848 |
| (21 Days) | 10.115 | 8.352 | 10.205 | 9.045 | 6.56 |
| (28 Days) | 10.148 | 8.175 | 10.678 | 8.204 | 6.345 |
| (38 Days) | 11.449 | 8.205 | 10.878 | 8.586 | 6.281 |
| (45 days) | 9.095 | 7.213 | 9.612 | 7.59 | 5.614 |
| (52 Days) | 10.609 | 7.906 | 10.314 | 7.903 | 5.949 |
| (70 Days) | 9.029 | 8.199 | 10.76 | 8.239 | 5.873 |
| (81 Days) | 10.497 | 8.171 | 10.685 | 7.952 | 6.018 |
| (90 Days) | 10.586 | 8.313 | 10.951 | 8.287 | 6.453 |
| (97 Days) | 10.788 | 8.268 | 10.929 | 8.645 | 6.128 |
| (112 Days) | 10.673 | 8.198 | 10.835 | 8.463 | 5.95 |

Sodium Carbonate %

| | | | | | |
|---|---|---|---|---|---|
| TOM | 0.962 | 0.912 | 1.479 | 0.891 | 0.632 |
| Hot Temp (100° F./38° C.), (7 Days) | 1.43 | 1.182 | 1.367 | 0.32 | |
| (14 Days) | 0.963 | 0.66 | 0.992 | 0.699 | 0.727 |
| (21 Days) | 0.863 | 1.005 | 0.975 | 0.772 | 0.679 |
| (28 Days) | 0.876 | 0.98 | 0.966 | 0.643 | 0.782 |
| (38 Days) | 1.002 | 0.988 | 1.201 | 0.711 | 1.038 |
| (45 days) | 0.686 | 0.554 | 0.697 | 0.493 | 0.506 |
| (52 Days) | 1.128 | 0.968 | 1.166 | 0.749 | 0.852 |
| (70 Days) | 0.663 | 0.761 | 0.947 | 0.737 | 0.58 |
| (81 Days) | 0.812 | 0.79 | 1.057 | 0.607 | 0.545 |
| (90 Days) | 1.045 | 1.03 | 1.116 | 0.823 | 0.981 |
| (97 Days) | 1.055 | 0.918 | 1.44 | 1.019 | 0.854 |
| (112 Days) | 0.992 | 1.187 | 0.915 | 0.97 | 0.773 |

Sodium Hypochlorite %

| TOM | 5.94 | 6.24 | 4.98 | 4.94 | 4.87 |
|---|---|---|---|---|---|
| Hot Temp (100° F./38° C.), (7 Days) | 5.92 (−0.3%) | 5.99 (−4.0%) | 4.97 (−0.2%) | 4.92 (−0.4%) | 4.82 (−1.0%) |
| (14 Days) | 5.84 (−1.6%) | 5.92 (−5.1%) | 4.91 (−1.4%) | 4.91 (−0.6%) | 4.80 (−1.5%) |
| (21 Days) | 5.83 (−1.9%) | 5.86 (−6.1%) | 4.89 (−1.8%) | 4.86 (−1.7%) | 4.71 (−3.3%) |
| (28 Days) | 5.8 (−2.3%) | 5.84 (−6.4%) | 4.87 (−2.2%) | 4.84 (−2.1%) | 4.66 (−4.3%) |
| (38 Days) | 5.75 (−3.2%) | 5.75 (−7.9%) | 4.79 (−3.8%) | 4.75 (−3.8%) | 4.60 (−5.5%) |
| (52 Days) | 5.63 (−5.3%) | 5.61 (−10.2%) | 4.73 (−4.9%) | 4.61 (−6.6%) | 4.45 (−8.7%) |
| (70 Days) | 5.54 (−6.7%) | 5.57 (−10.7%) | 4.65 (−6.5%) | 4.56 (−7.7%) | 4.31 (−11.6%) |
| (81 Days) | 5.51 (−7.2%) | 5.53 (−10.3%) | 4.63 (7.0%) | 4.62 (−6.6%) | 4.28 (−12.0%) |
| (90 Days) | 5.47 (−7.9%) | 5.46 (−12.6%) | 4.59 (−7.8%) | 4.48 (−9.3%) | 4.24 (−12.9%) |
| (97 Days) | 5.45 (−8.3%) | 5.41 (−13.3%) | 4.55 (−8.7%) | 4.47 (−9.6%) | 4.20 (−13.8%) |
| (112 Days) | 5.36 (−9.8%) | 5.36 (−14.2%) | 4.51 (−9.4%) | 4.42 (−10.5%) | 4.12 (−15.4%) |

TABLE 13
ASTM Stain Laundry Performance Data: Statistical Analysis Criteria
Comparison Value = (Prototype % SRE - Control % SRE)/LSD

| Comparison Value | Test Results |
|---|---|
| Between +1 and −1 | No Significant Difference-Parity |
| Greater than +1 | Prototype Superior to Control-Tide |
| Less than −1 | Prototype Inferior to Control-Tide |

Table 13 describes how the formulations were evaluated for efficacy in laundry performance using a top loading machine, 7% NaOCl 0.75 cup (177 ppm of NaOCl in wash load) at 5 minute delayed addition, with 150 ppm of hard water with Standard ASTM 15 Stained cotton flags. Data in the following Tables are from the “through the wash and not from pre-treatment and wash for Clorox 2® Stain Fighter & Color Booster (“LC2”) and Clorox Oxi Magic™.

TABLE 14

| | 15 ASTM Stains | | | | |
|---|---|---|---|---|---|
| | Clorox ® Reg. CLB | ClN(Na)SO₃Na | ClN(Na)SO₃Na | ClN(Na)SO₃Na | ClN(Na)SO₃Na |
| | vs.Tide ® detergent | vs.Tide ® detergent | vs. Tide ® detergent | vs.Clorox 2 ® | vs. Clorox ® OxiMagic ™ |
| | 110° F. | 110° F. | 93° F. | 93° F. | 93° F. |
| Wins | 12 | 8 | 8 | 6 | 6 |
| Losses | 1 | 2 | 1 | 0 | 0 |
| Parities | 2 | 5 | 6 | 9 | 9 |

In Table 14, the numbers represent the difference in Soil Removal when there was a Statistical Difference at 95% Confidence Index (Comparisons between Tide® detergent alone and Tide® detergent with Prototype Test Products)

TABLE 15

| | 15ASTMStains | | | | | |
|---|---|---|---|---|---|---|
| | Ex (#1-5) | Ex (#1&5) | Ex (#1&5) | Ex (#1-5) | Ex (#1-5) | Ex (#1&5) |
| | vs. Tide ® | vs. Clorox ® | vs. Tide ® | vs. Tide ® | vs. Tide ® | vs. Clorox ® |
| | detergent | OxiMagic ™ | detergent | detergent | detergent | 2 |
| | 68° F. | 93° F. | 110° F. | 68° F | 93° F | 93° F |
| Wins | 9-6 | 5-4 | 5-4 | 6 | 4 | 8-6 |
| Losses | 3-5 | 1-3 | 5-5 | 4 | 1 | 1-2 |
| Parities | 2-6 | 8-10 | 5-6 | 5 | 10 | 6-7 |

In Table 15, the numbers represent the difference in Soil Removal when there was a Statistical Difference at 95% Confidence Index (Comparisons Between Tide® detergent alone and Tide® detergent with Prototype Test Products, i.e., Examples 1-5 of Tables 1A-1B)

TABLE 16

| 15 Standard | Tide ® detergent vs. | Tide ® detergent |
|---|---|---|
| ASTM Stains | Clorox ® Reg. CLB | vs. ClN(Na)SO3Na |
| Grass | 5.69 | −12.77 |
| Coffee | 11.40 | 9.81 |
| Tea | 64.64 | 36.23 |
| Red Wine | 19.71 | 5.08 |
| Blueberry | 10.76 | 7.33 |
| Spaghetti Sauce | 26.14 | |
| Chocolate Syrup | | |
| Mustard | 41.76 | 46.65 |
| Gravy Mix | 8.07 | 2.75 |
| Ball Point Ink | 31.28 | |
| Sebum | 6.56 | |
| Bandy Clay | 11.44 | 4.04 |
| Grape Juice | 20.21 | 7.06 |
| Make Up | −5.25 | −20.03 |
| Dirty Motor Oil | | |
| Delta White | | −1.83 |
| Redeposition | | |
| | 12 Wins −1 Loss −4 Parities | 8 Wins −3 Losses |
| | | −6 Parities |

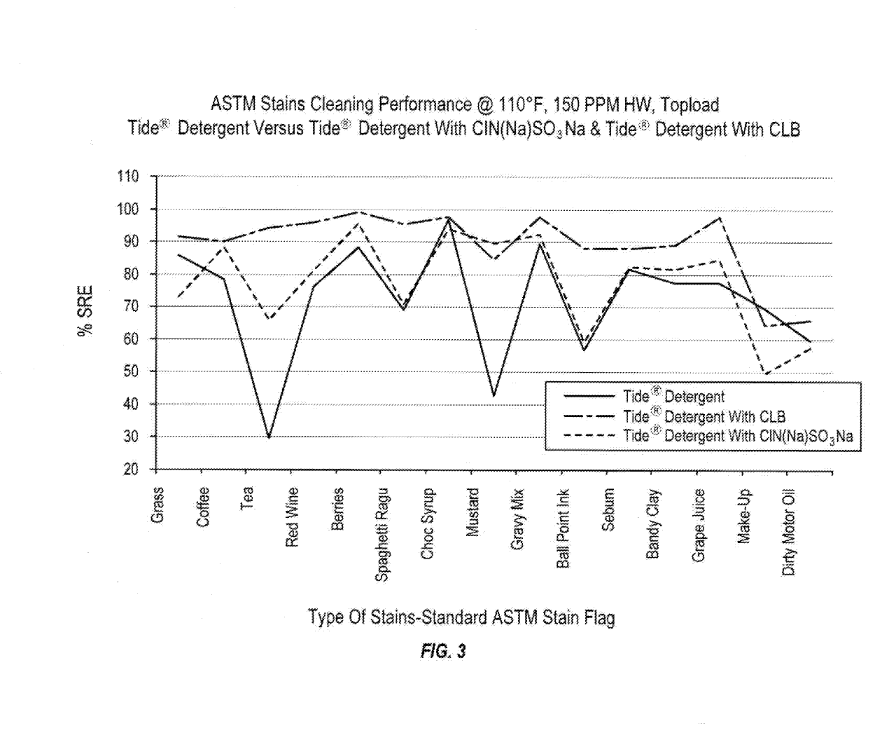

In Table 16, the numbers represent the difference in Soil Removal [% SR (E)] of Liquid Tide® detergent versus Tide® detergent with Clorox® Liquid Bleach and Tide® detergent with the inventive compositions when there was a statistical difference at the 95% Confidence Index. FIG. 3 shows these results tabulated in graphical form.

TABLE 17
ClN(Na)SO₃Na Versus Clorox ® 2 & Clorox ® OxiMagic ™: 15 ASTM Standard
Stains on Cotton, ASTM Cleaning Performance, Top Loading Machine @ 93° F., 150 ppm Hard
Water, ¾ Cup ClN(Na)SO₃Na (178 ppm NaOCl), 5 Minute Delay Add

| | | ASTM Stains | | | | | | | |
|---|---|---|---|---|---|---|---|---|---|
| | x Win, x Loss, | | | | | | Spaghetti | Choc | |
| Products | x Parity | Grass | Coffee | Tea | Red | Berries | Ragu | Syrup | Mustard |
| Tide ® | 15 Stains vs Tide ® | 87.88 | 81.49 | 44.14 | 86.38 | 88.98 | 73.07 | 96.64 | 37.32 |
| detergent | detergent | | | | | | | | |
| Clorox ® 2 | 1 Win, 0 Loss, | 84.47 | 82.15 | 40.52 | 82.62 | 89.52 | 77.43 | 97.23 | 39.27 |
| (Liquid) | 14 Parity | | | | | | | | |
| Clorox ® | 6 Win, 2 Loss, | 82.74 | 84.46 | 31.10 | 75.17 | 94.49 | 78.89 | 95.07 | 67.69 |
| OxiMagic ™ | 7 Parity | | | | | | | | |
| (Powder) | | | | | | | | | |
| Ex 1 (Higher | 6 Win, 3 Loss, | 79.73 | 87.87 | 60.54 | 82.40 | 95.54 | 76.77 | 94.40 | 83.64 |
| Alkalinity) | 6 Parity | | | | | | | | |
| Ex 5 (Lower | 8 Win, 1 Loss, | 77.87 | 88.83 | 78.36 | 86.86 | 97.48 | 86.10 | 96.40 | 88.02 |
| Alkalinity) | 6 Parity | | | | | | | | |
| Calculation | | % SR(E) | % SR(E) | % SR(E) | % SR(E) | % SR(E) | % SR(E) | % SR(E) | % SR(E) |
| LSD vs | | — | — | — | — | — | — | — | — |
| Washload | | | | | | | | | |
| HSD vs | | — | — | — | — | — | — | — | — |
| Washload | | | | | | | | | |
| LSD vs | | 7.970 | 3.487 | 39.517 | 13.037 | 2.009 | 9.954 | 1.431 | 14.403 |
| Pooled | | (NS) | | (NS) | (NS) | | (NS) | | |
| HSD vs | | 11.546 | 5.052 | 57.248 | 18.887 | 2.911 | 14.420 | 2.073 | 20.866 |
| pooled | | (NS) | | (NS) | (NS) | | (NS) | | |
| MS-Washload | | 28.43 | 3.87 | 599.71 | 56.83 | 2.23 | 31.35 | 0.32 | 83.86 |
| MS-Pooled | | 27.96 | 5.35 | 687.44 | 74.82 | 1.78 | 43.62 | 0.90 | 91.33 |

| | ASTM Stains | | | | | | | | |
|---|---|---|---|---|---|---|---|---|---|
| | Gravy | Ball Point | | Bandy | Grape | Make- | Dirty | | |
| Products | Mix | Ink | Sebum | Clay | Juice | Up | Motor Oil | Delta-W | Redep |
| Tide ® | 90.71 | 54.15 | 83.16 | 84.75 | 88.61 | 62.17 | 51.85 | 3.35 | 0.04 |
| detergent | | | | | | | | | |
| Clorox ® 2 | 92.04 | 56.72 | 82.37 | 86.46 | 84.15 | 60.63 | 56.05 | 4.68 | −0.05 |
| (Liquid) | | | | | | | | | |
| Clorox ® | 93.88 | 68.15 | 89.85 | 89.09 | 77.97 | 56.35 | 54.62 | 3.71 | 0.52 |
| OxiMagic ™ | | | | | | | | | |
| (Powder) | | | | | | | | | |
| Ex 1 (Higher | 92.52 | 59.93 | 87.81 | 88.61 | 90.15 | 47.81 | 53.46 | 2.77 | 0.16 |
| Alkalinity) | | | | | | | | | |
| Ex 5 (Lower | 92.90 | 56.76 | 87.91 | 88.01 | 91.33 | 53.53 | 54.96 | 3.31 | −0.37 |
| Alkalinity) | | | | | | | | | |
| Calculation | % SR(E) | % SR(L) | % SR(E) | % SR(E) | % SR(E) | % SR(E) | % SR(E) | Delta-W | Delta-W |
| LSD vs | — | — | — | — | — | — | — | — | — |
| Washload | | | | | | | | | |
| HSD vs | — | — | — | — | — | — | — | — | — |
| Washload | | | | | | | | | |
| LSD vs | 2.066 | 12.174 | 4.037 | 2.487 | 9.910 | 9.052 | 4.234 | 0.975 | 1.184 |
| Pooled | | (NS) | | | (NS) | | (NS) | | (NS) |
| HSD vs | 2.994 | 17.636 | 5.848 | 3.603 | 14.357 | 13.114 | 6.134 | 1.412 | 1.716 |
| pooled | | (NS) | | | (NS) | | (NS) | | (NS) |
| MS-Washload | 0.95 | 64.78 | 9.61 | 3.10 | 19.9 | 28.05 | 8.58 | 0.35 | 0.73 |
| MS-Pooled | 1.88 | 65.24 | 7.17 | 2.72 | 43.24 | 36.07 | 7.89 | 0.42 | 0.62 |

Bold = Statistically Significant Win Versus Tide ® detergent
Italics = Statistically Significant Loss Versus Tide ® detergent
Underline = No Statistically Significant Difference Versus Tide ® detergent

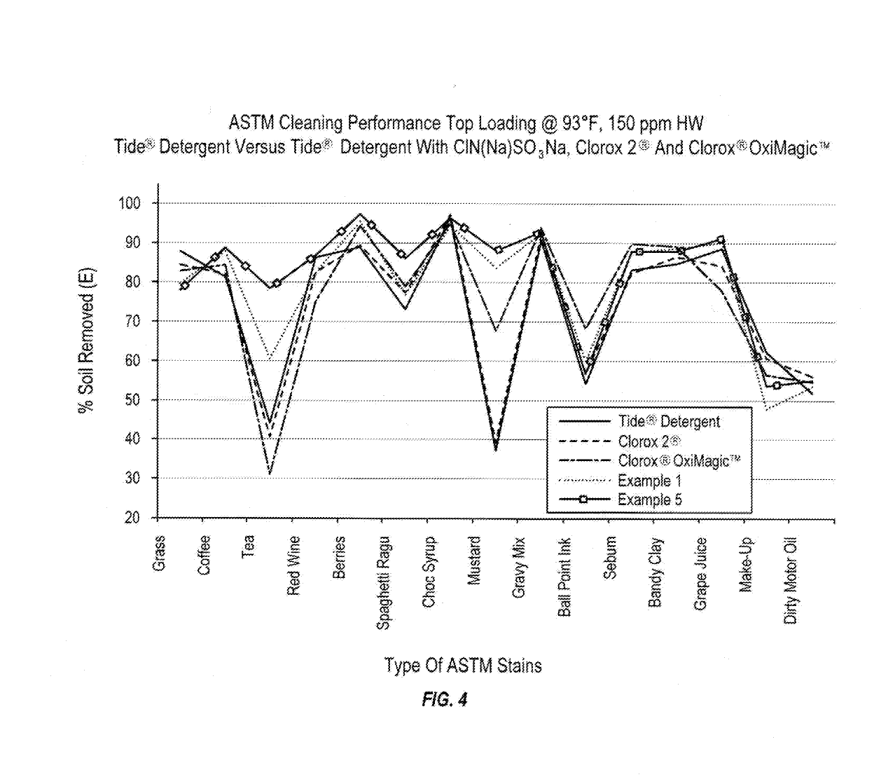

The results in Table 17 are also shown in graphical form in FIG. 4.

TABLE 18
ClN(Na)SO₃Na vs Clorox ® 2, Clorox ® OxiMagic ™ &
Tide ® detergent @ 93° F,. Top Loading Machine, Through The Wash Differences in % SR (E)

| | Formula | | | | | |
|---|---|---|---|---|---|---|
| | Clorox ® 2 | | Clorox ® OxiMagic ™ | | Tide ® detergent | |
| Stains | Ex 1 | Ex 5 | Ex 1 | Ex 5 | Ex 1 | Ex 5 |
| Grass LSD 7.970 (NS) | −4.74 | −6.60 | −3.01 | −4.87 | −8.15 | −10.01 |
| Coffee LSD 3.487 | 5.72 | 6.68 | 3.41 | 4.37 | 6.38 | 7.34 |
| Tea LSD 39.517 (NS) | 20.02 | 37.84 | 29.44 | 47.26 | 16.40 | 34.22 |
| Red Wine LSD 13.037 (NS) | −0.22 | 4.24 | 7.23 | 11.69 | −3.98 | 0.48 |
| Berries LSD 2.009 | 6.02 | 7.96 | 1.05 | 2.99 | 6.56 | 8.50 |
| Spaghetti Ragu LSD 9.954 (NS) | −0.66 | 8.67 | −2.12 | 7.21 | 3.70 | 13.03 |
| Chocolate Syrup LSD 1.431 | −2.83 | −0.83 | −0.67 | 1.33 | −2.24 | −0.24 |
| Mustard LSD 14.403 | 44.37 | 48.75 | 15.95 | 20.33 | 46.32 | 50.7 |
| Gravy Mix LSD 2.066 | 0.48 | 0.86 | −1.36 | −0.98 | 1.81 | 2.19 |
| Ball Point Ink LSD 12.174 (NS) | 3.21 | 0.04 | −8.22 | −11.39 | 5.78 | 2.61 |
| Sebum LSD 4.037 | 5.44 | 5.54 | −2.04 | −1.94 | 4.65 | 4.75 |
| Bandy Clay LSD 2.487 | 2.15 | 1.55 | −0.48 | −1.08 | 3.86 | 3.26 |
| Grape Juice LSD 9.910 (NS) | 6.00 | 7.18 | 12.18 | 13.36 | 1.54 | 2.72 |
| Make-Up LSD 9.052 | −12.82 | −7.10 | −8.54 | −2.82 | −14.36 | −8.64 |
| Dirty Motor Oil LSD 4.234 (NS) | −2.59 | −1.09 | −1.16 | 0.34 | 1.61 | 3.11 |
| Wins & Losses | 9 W 6 L | 11 W 4 L | 6 W 9 L | 9 W 6 L | 11 W 4 L | 12 W 3 L |

| | | |
|---|---|---|
| BEST | BETTER | BEST BEST |

Bold = Statistically Significant Win Versus Tide ® detergent
Italics = Statistically Significant Loss Versus Tide ® detergent

TABLE 19
ClN(Na)SO₃Na vs Clorox ® 2, Clorox ® OxiMagic ™ &
Tide ® detergent @ 93° F., Top Loading Machine, Through The Wash Differences in % SR (E)/LSD

| | Formula | | | | | |
|---|---|---|---|---|---|---|
| | Clorox ® 2 | | Clorox ® OxiMagic ™ | | Tide ® detergent | |
| Stains | Ex 1 | Ex 5 | Ex 1 | Ex 5 | Ex 1 | Ex 5 |
| Grass LSD 7.970 (NS) | −0.59 | −0.83 | −0.38 | −0.61 | −1.02 | −10.01 |
| Coffee LSD 3.487 | 1.64 | 1.92 | 0.98 | 1.25 | 1.83 | 2.10 |
| Tea LSD 39.517 (NS) | 0.51 | 0.96 | 0.74 | 1.20 | 0.42 | 0.87 |
| Red Wine LSD 13.037 (NS) | −0.02 | 0.33 | 0.55 | 0.90 | −0.31 | 0.04 |
| Berries LSD 2.009 | 3.00 | 3.96 | 0.52 | 1.49 | 3.27 | 4.23 |
| Spaghetti Ragu LSD 9.954 (NS [symbol] | −0.66 | 8.67 | −2.12 | 7.21 | 3.70 | 13.03 |
| Chocolate Syrup LSD 1.431 | −1.98 | −0.58 | −0.47 | 0.93 | −1.57 | −0.17 |
| Mustard LSD 14.403 | 3.08 | 3.38 | 1.11 | 1.41 | 3.22 | 3.52 |
| Gravy Mix LSD 2.066 | 0.23 | 0.42 | −0.66 | −0.47 | 0.88 | 1.06 |
| Ball Point Ink LSD 12.174 (NS) | 0.26 | 0.00 | −0.68 | −0.94 | 0.47 | 0.21 |
| Sebum LSD 4.037 | 1.35 | 1.37 | −0.51 | −0.48 | 1.15 | 1.18 |
| Bandy Clay LSD 2.487 | 0.86 | 0.62 | −0.19 | −0.43 | 1.55 | 1.31 |
| Grape Juice LSD 9.910 (NS) | 0.61 | 0.72 | 1.23 | 1.35 | 0.16 | 0.27 |
| Make-Up LSD 9.052 | −1.42 | −0.78 | −0.94 | −0.31 | −1.59 | −0.95 |
| Dirty Motor Oil LSD 4.234 (NS) | −0.61 | −0.26 | −0.27 | 0.08 | 0.38 | 0.73 |
| Wins & Losses | 4 W 9 P 2 L | 6 W 9 P 0 L | 3 W 11 P 1 L | 6 W 9 P 0 L | 6 W 7 P 2 L | 8 W 6 P 1 L |

| | | | |
|---|---|---|---|
| BETTER | BETTER | BETTER | BEST |

Bold = Statistically Significant Win Versus Tide ® detergent
Italics = Statistically Significant Loss Versus Tide ® detergent
Underline = No Statistically Significant Difference Versus Tide ® detergent [symbol]
indicates data missing or illegible when filed

TABLE 20
ClN(Na)SO₃Na vs Tide ® detergent @ 68° F., Top Loading Machine, Differences in % SR (E)

| Stains/Formula | Ex 1 | Ex 2 | Ex 3 | Ex 4 | Ex 5 |
|---|---|---|---|---|---|
| Grass (LSD vs Pooled 14.570 NS) | −15.97 | −14.96 | −22.38 | −14.18 | −21.21 |
| Coffee (LSD vs Pooled 2.498) | 7.22 | 8.18 | 7.30 | 7.49 | 6.56 |
| Tea (LSD vs Pooled 6.062) | 28.77 | 33.86 | 29.11 | 32.73 | 26.18 |
| Red Wine (LSD vs Pooled 2.73) | 1.78 | 3.66 | 3.21 | 3.75 | 2.92 |
| Berries (LSD vs Pooled 1.707) | 10.82 | 12.11 | 12.92 | 13.33 | 11.90 |
| Spaghetti Ragu (LSD vs Pooled 6.533) | 14.25 | 7.95 | 11.33 | 6.37 | 6.99 |
| Chocolate Syrup (LSD vs Pooled 2.614 NS) | −1.61 | −2.78 | −1.22 | −1.50 | −0.60 |
| Mustard (LSD vs Pooled 3.988) | 58.39 | 58.23 | 57.18 | 56.47 | 52.60 |
| Gravy Mix (LSD vs Pooled 1.897) | 1.09 | 2.03 | 2.55 | 1.62 | 1.66 |
| Ball Point Ink (LSD vs Pooled 3.409) | 2.41 | 2.98 | 0.39 | −0.14 | −1.62 |
| Sebum (LSD vs Pooled 8.237 NS) | 2.96 | −1.42 | −0.01 | −0.60 | 2.10 |
| Bandy Clay (LSD vs Pooled 1.788 NS) | 0.76 | 2.07 | 0.99 | 1.36 | 1.47 |
| Grape Juice (LSD vs Pooled 3.866) | 4.33 | 6.31 | 5.22 | 4.90 | 1.40 |
| Make-Up (LSD vs Pooled 3.986) | −7.07 | −7.34 | −5.97 | −5.05 | −2.28 |
| Dirty Motor Oil (LSD vs Pooled 3.50 NS) | 2.63 | 0.14 | 3.02 | 3.13 | 1.86 |
| Wins & Losses | 12 W 3 L | 11 W 4 L | 11 W 4 L | 10 W 5 L | 10 W 5 L |

Bold = Statistically Significant Win Versus Tide ® detergent
Italics = Statisically Significant Loss Versus Tide ® detergent

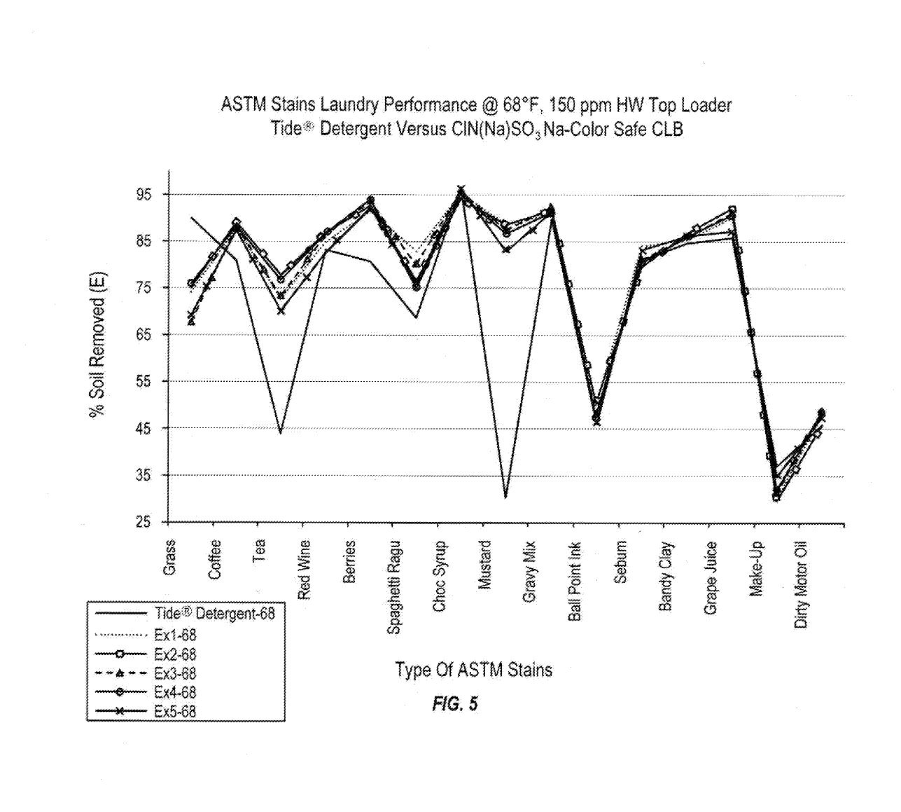

The data in Table 20 is also presented in graphical form in FIG. 5.

TABLE 21
Examples (1-5) vs Tide ® detergent @ 68° F., Top Loading Machine, Differences in % SR (E)/LSD

| Stains/Formula | Ex 1 | Ex 2 | Ex 3 | Ex 4 | Ex 5 |
|---|---|---|---|---|---|
| Grass (LSD vs Pooled 14.570 NS) | −1.10 | −1.03 | −1.54 | −0.97 | −1.46 |
| Coffee (LSD vs Pooled 2.498) | 2.89 | 3.27 | 2.92 | 3.00 | 2.63 |
| Tea (LSD vs Pooled 6.062) | 4.75 | 5.59 | 4.80 | 5.40 | 4.32 |
| Red Wine (LSD vs Pooled 2.73) | 0.65 | 1.34 | 1.18 | 1.37 | 1.07 |
| Berries (LSD vs Pooled 1.707) | 6.34 | 7.09 | 7.57 | 7.81 | 6.97 |
| Spaghetti Ragu (LSD vs Pooled 6.533) | 2.18 | 1.22 | 1.73 | 0.98 | 1.07 |
| Chocolate Syrup (LSD vs Pooled 2.614 NS) | −0.62 | −1.06 | −0.47 | −0.57 | −0.23 |
| Mustard (LSD vs Pooled 3.988) | 14.64 | 14.60 | 14.34 | 14.16 | 13.19 |
| Gravy Mix (LSD vs Pooled 1.897) | 0.57 | 1.07 | 1.34 | 0.85 | 0.88 |
| Ball Point Ink (LSD vs Pooled 3.409) | 0.71 | 0.87 | 0.11 | −0.04 | −0.48 |
| Sebum (LSD vs Pooled 8.237 NS) | 0.36 | −0.17 | 0.00 | −0.07 | 0.25 |
| Bandy Clay (LSD vs Pooled 1.788 NS) | 0.43 | 1.16 | 0.55 | 0.76 | 0.82 |
| Grape Juice (LSD vs Pooled 3.866) | 1.12 | 1.63 | 1.35 | 1.27 | 0.36 |
| Make-Up (LSD vs Pooled 3.986) | −7.07 | −7.34 | −5.97 | −5.05 | −2.28 |
| Dirty Motor Oil (LSD vs Pooled 3.50 NS) | 0.75 | 0.04 | 0.86 | 0.89 | 0.53 |
| Wins, Losses & Parities over Liquid Tide | 6 W 3 L 6 P | 9 W 4 L 2 P | 8 W 3 L 4 P | 7 W 5 L 3 P | 6 W 4 L 5 P |

9 WINS-DANE
Bold = Statistically Significant Win Versus Tide ® detergent
Italics = Statistically Significant Loss Versus Tide ® detergent
Underline = No Statistically Significant Difference Versus Tide ® detergent

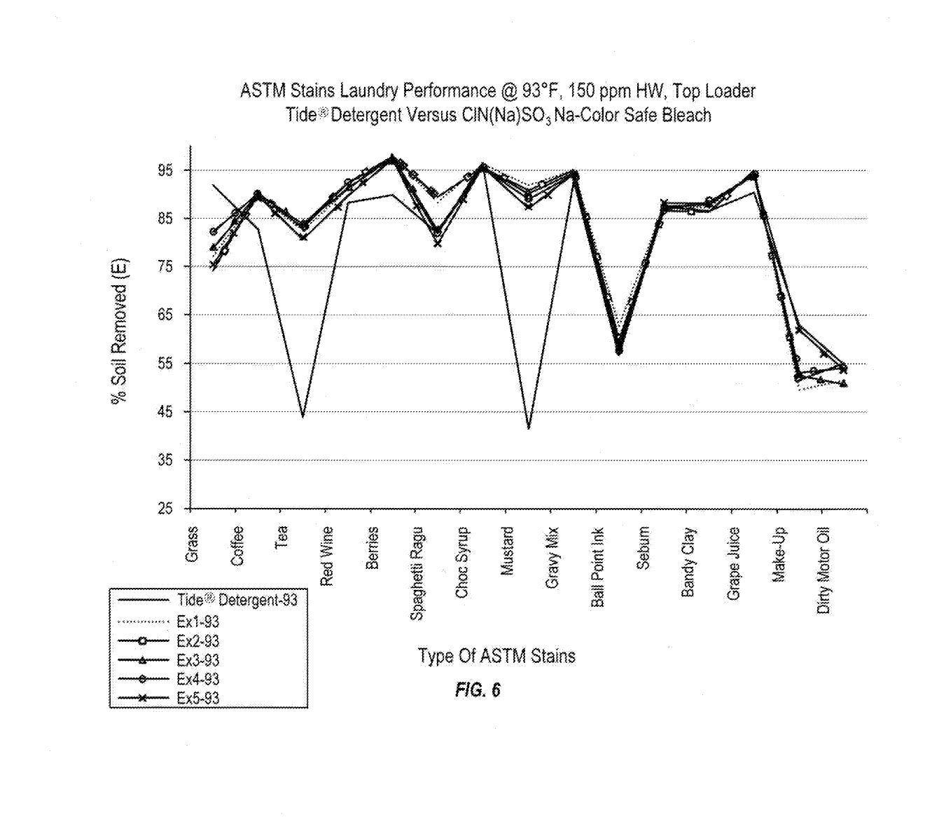

The data in Table 21 is also presented in graphical form in FIG. 6.

TABLE 22
CIN(Na)SO₃Na vs Tide ® detergent @ 93° F., Top Loading Machine, Differences in % SR (E)

| Stains/Formula | Ex 1 | Ex 2 | Ex 3 | Ex 4 | Ex 5 |
|---|---|---|---|---|---|
| Grass (LSD vs Pooled 7.483) | −14.7 | −17.75 | −13.28 | −9.68 | −16.57 |
| Coffee (LSD vs Pooled 1.951) | 6.94 | 7.26 | 7.30 | 7.42 | 7.04 |
| Tea (LSD vs Washload 26.712) | 38.54 | 39.2 | 39.97 | 39.95 | 36.75 |
| Red Wine (LSD vs Washload 8.613 NS) | 2.83 | 4.08 | 2.97 | 4.19 | 1.49 |
| Berries (LSD vs Washload 2.95) | 7.92 | 7.99 | 7.59 | 7.27 | 7.43 |
| Spaghetti Ragu (LSD vs Washload 7.722 NS) | 6.43 | 7.51 | 0.37 | −0.04 | −2.24 |
| Chocolate Syrup (LSD vs Pooled 1.467 NS) | −0.34 | −0.99 | −1.04 | −1.07 | −0.89 |
| Mustard (LSD vs Washload 11.004) | 50.48 | 49.51 | 48.76 | 47.62 | 45.78 |
| Gravy Mix (LSD vs Washload 2.673 NS) | 2.24 | 2.13 | 1.63 | 1.39 | 1.61 |
| Ball Point Ink (LSD vs Washload 11.081 NS) | 6.14 | 3.15 | 2.11 | 0.70 | 1.42 |
| Sebum (LSD vs Pooled 3.554 NS) | −0.11 | −0.8 | −0.14 | −0.63 | 0.76 |
| Bandy Clay (LSD vs Pooled 1.958 NS) | 0.95 | 0.07 | 1.31 | 1.90 | 1.54 |
| Grape Juice (LSD vs Washload 6.716 NS) | 4.48 | 4.27 | 3.85 | 3.64 | 3.5 |
| Make-Up (LSD vs Pooled 4.77) | −13.36 | −11.36 | −10.41 | −9.72 | −0.95 |
| Dirty Motor Oil (LSD vs Pooled 3.428) | −3.24 | 0.26 | −4.21 | −0.73 | −1.2 |
| Wins & Losses | 10 W 5 L | 11 W 4 L | 10 W 5 L | 9 W 6 L | 10 W 5 L |

Bold = Statistically Significant Win Versus Tide ® detergent
Italics = Statistically Significant Loss Versus Tide ® detergent

TABLE 23
Examples (1-5) vs Tide ® detergent @ 93° F., Top Loading Machine, Differences in % SR (E)/LSD

| Stains/Formula | Ex 1 | Ex 2 | Ex 3 | Ex 4 | Ex 5 |
|---|---|---|---|---|---|
| Grass (LSD vs Pooled 7.483) | −1.96 | −2.27 | −1.77 | −1.29 | −2.21 |
| Coffee (LSD vs Pooled 1.951) | 3.56 | 3.72 | 3.74 | 3.80 | 3.61 |
| Tea (LSD vs Washload 26.712) | 1.44 | 1.47 | 1.50 | 1.50 | 1.38 |
| Red Wine (LSD vs Washload 8.613 NS) | 0.33 | 0.47 | 0.34 | 0.49 | 0.17 |
| Berries (LSD vs Washload 2.95) | 2.68 | 2.71 | 2.57 | 2.46 | 2.52 |
| Spaghetti Ragu (LSD vs Washload 7.722 NS) | 0.83 | 0.97 | 0.05 | −0.01 | −0.29 |
| Chocolate Syrup (LSD vs Pooled 1.467 NS) | −0.23 | −0.67 | −0.71 | −0.73 | −0.61 |
| Mustard (LSD vs Washload 11.004) | 4.59 | 4.50 | 4.43 | 4.33 | 4.16 |
| Gravy Mix (LSD vs Washload 2.673 NS) | 0.84 | 0.80 | 0.61 | 0.52 | 0.60 |
| Ball Point Ink (LSD vs Washload 11.081 NS) | 0.55 | 0.28 | 0.19 | 0.06 | 0.13 |
| Sebum (LSD vs Pooled 3.554 NS) | −0.03 | −0.23 | −0.04 | −0.18 | 0.21 |
| Bandy Clay (LSD vs Pooled 1.958 NS) | 0.49 | 0.04 | 0.67 | 0.97 | 0.79 |
| Grape Juice (LSD vs Washload 6.716 NS) | 0.67 | 0.64 | 0.62 | 0.59 | 0.52 |
| Make-Up (LSD vs Pooled 4.77) | −2.80 | −2.38 | −2.18 | −2.04 | −0.2 |
| Dirty Motor Oil (LSD vs Pooled 3.428) | −0.95 | 0.08 | −1.23 | −0.21 | −0.35 |
| Wins, Losses & Parities over Tide ® detergent | 4 W 2 L 9 P | 4 W 2 L 9 P | 4 W 3 L 8 P | 5 W 2 L 8 P | 4 W 1 L 10 P |

Bold = Statistically Significant Win Versus Tide ® detergent
Italics = Statistically Significant Loss Versus Tide ® detergent
Underline = No Statistically Significant Difference Versus Tide ® detergent

TABLE 24
CIN(Na)SO₃Na vs Tide ® detergent @ 110° F., Top Loading Machine, Differences in % SR (E)

| Stains/Formula | Ex 1 | Ex 2 | Ex 3 | Ex 4 | Ex 5 |
|---|---|---|---|---|---|
| Grass (LSD vs Pooled 7.483) | −14.71 | −17.75 | −13.28 | −9.68 | −16.57 |
| Coffee (LSD vs Pooled 1.951) | 6.94 | 7.26 | 1.08 | 7.42 | 7.10 |
| Tea (LSD vs Washload 26.712) | 38.54 | 39.2 | 39.97 | 39.95 | 36.75 |
| Red Wine (LSD vs Washload 8.613 NS) | 2.83 | 4.08 | 2.97 | 4.19 | 1.49 |
| Berries (LSD vs Washload 2.95) | 7.92 | 7.99 | 7.59 | 7.27 | 7.43 |
| Spaghetti Ragu (LSD vs Washload 7.722 NS) | 6.43 | 7.51 | 0.37 | 0.04 | −2.24 |
| Chocolate Syrup (LSD vs Pooled 1.467 NS) | −0.34 | −0.99 | −1.04 | −1.07 | −0.89 |
| Mustard (LSD vs Washload 11.004) | 50.48 | 49.51 | 48.76 | 47.62 | 45.78 |
| Gravy Mix (LSD vs Washload 2.673 NS) | 2.24 | 2.13 | 1.63 | 1.39 | 1.61 |
| Ball Ppoint Ink (LSD vs Washload 11.081 NS) | 6.04 | 3.15 | 2.11 | 0.7 | 1.42 |
| Sebum (LSD vs Pooled 3.554 NS) | −0.11 | −0.80 | −0.14 | −0.63 | 0.76 |
| Bandy Clay (LSD vs Pooled 1.958 NS) | 0.95 | −0.07 | 1.31 | 1.90 | 1.54 |
| Grape Juice (LSD vs Washload 6.716 NS) | 4.48 | 4.27 | 3.85 | 3.64 | 3.50 |
| Make-Up (LSD vs Pooled 4.77) | −13.36 | −11.36 | −10.41 | −9.72 | −0.95 |
| Dirty Motor Oil (LSD vs Pooled 3.428) | −3.24 | 0.26 | −4.15 | −0.73 | −1.20 |
| Wins & Losses | 10 W 5 L | 10 W 5 L | 10 W 5 L | 10 W 5 L | 9 W 6 L |

Bold = Statistically Significant Win Versus Tide ® detergent
Italics = Statistically Significant Loss Versus Tide ® detergent

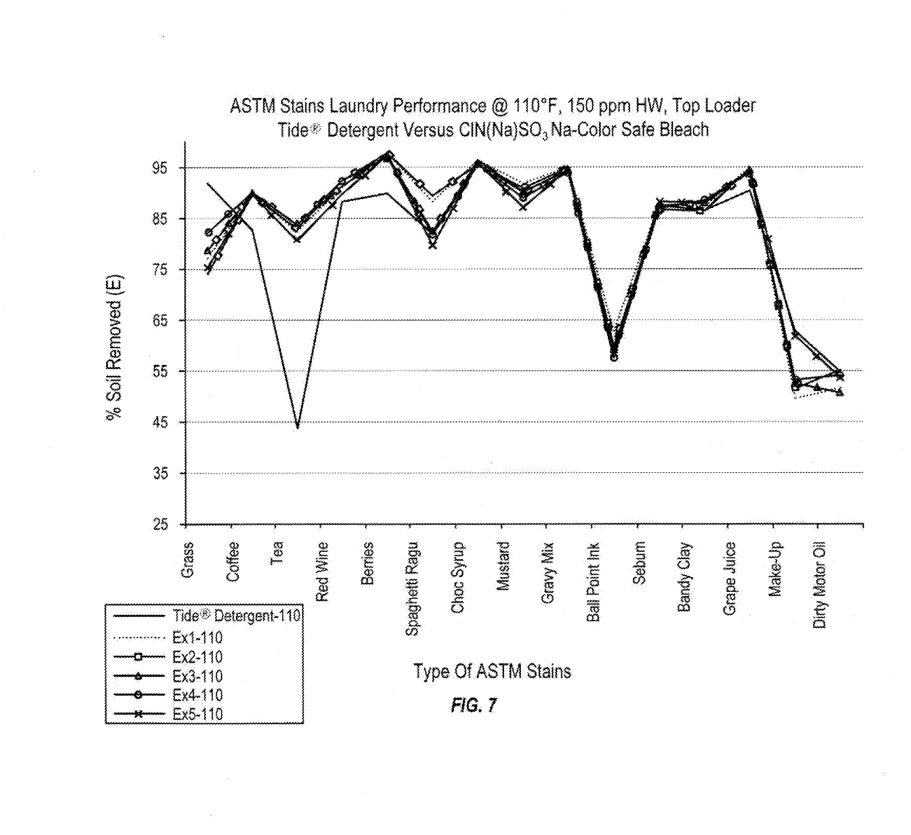

The data in Table 24 is also presented in graphical form in FIG. 7.

TABLE 25
Examples (1-5) vs Tide ® detergent @ 110° F., Top Loading Machine, Differences in % SR (E)/LSD

| Stains/Formula | Ex 1 | Ex 2 | Ex 3 | Ex 4 | Ex 5 |
|---|---|---|---|---|---|
| Grass (LSD vs Pooled 7.483) | −1.97 | −2.37 | −1.77 | −1.29 | −2.21 |
| Coffee (LSD vs Pooled 1.951) | 3.56 | 3.72 | 0.55 | 3.80 | 3.64 |
| Tea (LSD vs Washload 26.712) | 1.44 | 1.47 | 1.50 | 1.50 | 1.38 |
| Red Wine (LSD vs Washload 8.613 NS) | 0.35 | 0.50 | 0.34 | 0.23 | 0.17 |
| Berries (LSD vs Washload 2.95) | 2.68 | 2.71 | 2.57 | 2.46 | 2.52 |
| Spaghetti Ragu (LSD vs Washload 7.722 NS) | 0.83 | 0.97 | 0.05 | 0.01 | −0.29 |
| Chocolate Syrup (LSD vs Pooled 1.467 NS) | −0.23 | −0.67 | −0.71 | −0.73 | −0.61 |
| Mustard (LSD vs Washload 11.004) | 4.59 | 4.50 | 4.43 | 4.33 | 4.16 |
| Gravy Mix (LSD vs Washload 2.673 NS) | 0.84 | 0.80 | 0.61 | 0.52 | 0.60 |
| Ball Ppoint Ink (LSD vs Washload 11.081 NS) | 0.55 | 0.28 | 0.19 | 0.06 | 0.13 |
| Sebum (LSD vs Pooled 3.554 NS) | −0.03 | −0.23 | −0.04 | −0.18 | 0.21 |
| Bandy Clay (LSD vs Pooled 1.958 NS) | 0.49 | −0.04 | 0.67 | 0.97 | 0.79 |
| Grape Juice (LSD vs Washload 6.716 NS) | 0.67 | 0.64 | 0.57 | 0.54 | 0.57 |
| Make-Up (LSD vs Pooled 4.77) | −2.80 | −2.38 | −2.18 | −2.04 | −0.20 |
| Dirty Motor Oil (LSD vs Pooled 3.428) | −0.95 | 0.08 | −1.21 | −0.21 | −0.35 |
| Wins, Losses & Parities over Tide ® detergent | 4 W 5 L 6 P | 5 W 5 L 5 P | 4 W 5 L 6 P | 5 W 5 L 5P | 4 W 5 L 6 P |

Bold = Statistically Significant Win Versus Tide ® detergent
Italics = Statistically Significant Loss Versus Tide ® detergent
Underline = No Statistically Significant Difference Versus Tide ® detergent

TABLE 26
Stabilized NaOCl Releasing ClN(Na)SO₃Na

| | 7.36% Av Cl2 | | | | 3.68% Av Cl2 | | | |
|---|---|---|---|---|---|---|---|---|
| | 7.00% NaOCl | | | | 3.50% NaOCl | | | |
| | | Ex 126 | Ex 127 | Ex 128 | | Ex 129 | Ex 130 | Ex 131 |
| Ingredients | Control | Regular Bleach | | | Control | Regular Bleach | | |
| Water (Deionized) | 52.05 | 38.63 | 39.13 | 39.63 | 76.03 | 68.32 | 68.82 | 69.32 |
| Sodium Hydroxide (50%) | | 2.000 | 1.500 | 1.000 | | 2.000 | 1.500 | 1.000 |
| Sodium Sulfamate (98%) | | 11.42 | 11.42 | 11.42 | | 5.71 | 5.71 | 5.71 |
| Sodium Hypochlorite (12.00%)-Regular | 47.95 | 47.95 | 47.95 | 47.95 | 23.97 | 23.97 | 23.97 | 23.97 |
| | 100.00 | 100.00 | 100.00 | 100.00 | 100.00 | 100.00 | 100.00 | 100.00 |
| Moles of Sodium Sulfamate (119.07) | | 0.094 | 0.094 | 0.094 | | 0.047 | 0.047 | 0.047 |
| Moles of Sodium Hydroxide (MW 39.9971) | | 0.025 | 0.019 | 0.013 | | 0.025 | 0.019 | 0.013 |
| Added NaOH (50%), % | | 2.000 | 1.500 | 1.000 | | 2.000 | 1.500 | 1.000 |
| Moles of Sodium Hypochlorite (MW 74.442) | 0.094 | 0.094 | 0.094 | 0.094 | 0.047 | 0.047 | 0.047 | 0.047 |

pH (Neat)

| | | | | | | | | |
|---|---|---|---|---|---|---|---|---|
| TOM | 12.04 | 12.74 | 12.71 | 12.62 | 11.91 | 12.84 | 12.61 | 12.59 |
| Hot Temp, 100° F./38° C.) (6 Days) | | | | | | | | |

Sodium Hydroxide %

| | | | | | | | | |
|---|---|---|---|---|---|---|---|---|
| TOM | 0.121 | 4.281 | 4.049 | 3.84 | −0.141 | 2.683 | 2.32 | 2.089 |
| Hot Temp, 100° F./38° C.) (6 Days) 1 | | | | | | | | |

Sodium Carbonate %

| | | | | | | | | |
|---|---|---|---|---|---|---|---|---|
| TOM | 0.047 | 0.574 | 0.626 | 0.56 | 0.373 | 0.358 | 0.396 | 0.57 |
| Hot Temp, 100° F./38° C.) (6 Days) | | | | | | | | |

Sodium Hypochlorite %

| | | | | | | | | |
|---|---|---|---|---|---|---|---|---|
| TOM | 7.044 | 7.028 | 6.996 | 6.988 | 3.527 | 3.512 | 3.529 | 3.514 |
| Hot Temp, 100° F./38° C.) (6 Days) | | | | | | | | |

Table 26 shows exemplary formulations prepared from sodium sulfamate.

In further testing, some of the prepared sodium monochloro (sodio) sulfamate compositions were exposed directly to blue denim and colored striped fabrics for up to 10 minutes in undiluted concentration (e.g., equivalent to 7% NaOCl) and compared to regular hypochlorite bleach compositions. No fading occurred with the sodium monochloro (sodio) sulfamate treated fabrics, while the regular hypochlorite bleach compositions resulted in substantially complete discoloration of the fabric. Even when soaked in such concentrated solutions overnight or for one week, no significant color changes occurred, while the hypochlorite bleach compositions disintegrated the fabric to a cellulosic pulp bleached of all color after overnight soaking.

When subjected to sniff testing, the sodium monochloro (sodio) sulfamate compositions exhibited no significant “chlorine bleach” odor. The data presented in the Tables and Figures show that the sodium monochloro (sodio) sulfamate compositions are shelf stable compositions capable of slow release of sodium hypochlorite, barely degrading at storage temperatures of 100° F., while the control composition with no stabilization lost substantially all sodium hypochlorite within 4 months (120 days) of storage. The compositions are color-safe, so as to not fade or damage colored fabrics and dyes on continuous 10 wash cycles compared to regular hypochlorite which significantly faded the dyes of the wash loads, while being substantially free of any “chlorine bleach” odor.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims. For example, while described in the context of hypochlorite complexing sulfamates, it will be understood that analogous complexes based on other hypohalites (e.g., hypobromite, hypoiodite) could be provided.

1. A liquid aqueous composition comprising:
(a) about 0.1% to about 30% by weight of a bleaching agent selected from the group consisting of sodium monochloro (sodio) sulfamate, potassium monochloro (potassio) sulfamate, lithium monochloro (lithio) sulfamate, and mixtures thereof;
(b) about 0.1 to about 20% by weight of a buffer selected from the group consisting of an alkali metal hydroxide, alkali metal oxide and mixtures thereof; and
(c) wherein the pH of the composition is greater than 11.

2. The composition of claim 1, wherein the bleaching agent comprises sodium monochloro (sodio) sulfamate.

3. The composition of claim 1, wherein the bleaching agent is present in an amount from about 1% to about 20% by weight of the composition.

4. The composition of claim 1, wherein the bleaching agent is present in an amount from about 10% to about 20% by weight of the composition.

5. The composition of claim 5, wherein the alkali metal hydroxide comprises sodium hydroxide.

6. The composition of claim 5, wherein the alkali metal hydroxide is present in an amount from about 0.1% to about 10% by weight of the composition.

7. The composition of claim 5, wherein the alkali metal hydroxide is present in an amount from about 1% to about 5% by weight of the composition.

8. The composition of claim 1, wherein a concentration of active hypochlorite bleaching agents in the composition is less than about 1%.

9. The composition of claim 1, wherein a concentration of active hypochlorite bleaching agents in the composition is less than about 0.1%.

10. The composition of claim 1, wherein the composition is essentially free of buffering agents.

11. The composition of claim 1, further comprising at least one member selected from the group consisting of silicate, surfactant, chelating agent, sequestrant, preservative, fragrance, and mixtures thereof.

12. The composition of claim 11, wherein the composition comprises a silicate.

13. The composition of claim 11, wherein the composition comprises a surfactant.

14. A liquid, aqueous composition comprising:
(a) about 0.1% to about 20% by weight of a bleaching agent selected from the group consisting of sodium monochloro (sodio) sulfamate, potassium monochloro (potassio) sulfamate, lithium monochloro (lithio) sulfamate, and mixtures thereof;
(b) about 0.1 to about 10% of a buffer selected from the group consisting of an alkali metal hydroxide, an alkali metal oxide and mixtures thereof;
(c) wherein the composition is essentially free of sodium N-chlorosulfamate and sodium N,N-dichlorosulfamate; and
(d) wherein the pH of the composition is greater than 11.

15. The composition of claim 14, wherein the metal hydroxide or the metal oxide is present in an amount from about 1% to about 5% by weight of the composition.

16. The composition of claim 14, wherein a concentration of active hypochlorite bleaching agents in the composition is less than about 1%.

17. A liquid aqueous laundry composition comprising:
(a) about 0.1% to about 20% by weight of a bleaching agent selected from the group consisting of sodium monochloro (sodio) sulfamate, potassium monochloro (potassio) sulfamate, lithium monochloro (lithio) sulfamate, and mixtures thereof;
(b) about 0.1 to about 5% of a buffer selected from the group consisting of an alkali metal hydroxide, an alkali metal oxide and mixtures thereof; and
(c) wherein the pH of the composition is greater than 11.

18. The composition of claim 17, wherein the alkali metal hydroxide or the alkali metal oxide is present in an amount from about 1% to about 5% by weight of the composition.

19. The composition of claim 17, wherein a concentration of active hypochlorite bleaching agents in the composition is less than about 1%.

20. The composition of claim 17, wherein the composition comprises a silicate.
